(19) United States
(12) Patent Application Publication
(10) Pub. No.: US 2013/0219362 A1
(43) Pub. Date: Aug. 22, 2013

(54) DESIGN RULE HIERARCHY, TASK PARALLELISM, AND DEPENDENCY ANALYSIS IN LOGICAL DECISION MODELS

(71) Applicants: Yuanfang Cai, Paoli, PA (US); Sunny Wong, Phoenixville, PA (US)

(72) Inventors: Yuanfang Cai, Paoli, PA (US); Sunny Wong, Phoenixville, PA (US)

(73) Assignee: Drexel University, Philadelphia, PA (US)

(21) Appl. No.: 13/819,136

(22) PCT Filed: Aug. 30, 2011
(86) PCT No.: PCT/US11/49707

§ 371 Date: May 9, 2013

Related U.S. Application Data
(60) Provisional application No. 61/378,007, filed on Aug. 30, 2010.
(60) Provisional application No. 61/378,011, filed on Aug. 30, 2010.

(51) Int. Cl. G06F 9/44

(52) U.S. Cl. CPC G06F 8/74
USPC 717/123

(57) ABSTRACT

A binary augmented constraint network (BACN) allows dependency relationships to be determined without solving constraints. BACN models design decisions as first-class members and expresses how decisions make assumptions upon each other using logical constraints. Pairwise dependency relations (PWDRs) are determined based on the BACN. A design rule hierarchy (DRH) based on assumption relations among design decisions identifies parallelizable tasks within software design. Modules within the same layer of the hierarchy suggest concurrent tasks. Dependencies between layers or within a module suggest possible need for communication. In one configuration, decisions within the top layer of the hierarchy are the most influential design rules, which dominate the rest of the system, and are kept stable. The decisions within subsequent layers assume design decisions in previous layers. The design decisions within each layer are clustered into modules. Modules within the same layer are independent from each other and are candidates for concurrent implementation.

### CROSS REFERENCE TO RELATED APPLICATIONS

The instant application claims benefit to U.S. provisional patent application No. 61/378,007, entitled “Improving the Efficiency Of Dependency Analysis In Logical Decision Models,” filed Aug. 30, 2010, which is hereby incorporated by reference in its entirety. The instant application also claims benefit to U.S. provisional patent application No. 61/378,011, entitled “Design Rule Hierarchy And Task Parallelism,” filed Aug. 30, 2010, which is hereby incorporated by reference in its entirety.

### STATEMENT REGARDING FEDERALLY-SPONSORED RESEARCH AND DEVELOPMENT

The invention was made with United States Government support under award/grant number CCF-0916891 awarded by the National Science Foundation (NSF). The United States Government has certain rights in the invention.

### TECHNICAL FIELD

The technical field generally relates to software development, and more specifically relates to a design rule hierarchy and dependency analysis in logical decision models.

### BACKGROUND

In today's large-scale, distributed software development projects, it is increasingly crucial to maximize the level of concurrency among development tasks, and at the same time avoid incurring huge coordination overhead among development teams tasked with concurrent work. A problem is that prevailing design models are not designed to effectively suggest how tasks can be maximally parallelized.

It has been long recognized that software modularization plays a critical role in streamlining project coordination, as the need for coordination among developers is closely related to the dependency structure within the system. However, there is lack formal and effective means to reason about how development tasks can be constructed, partitioned, and assigned to maximize parallelization of work based on the dependency relations in the system, as prevailing software models are not designed to provide guidance on these matters.

Software modular structure, determined by component dependencies, influences the ease of change accommodation, communication needs among developers, and economic value of software. A problem with existing software dependency extraction methods is that they do not work on higher-level software artifacts, do not express decisions explicitly, and do not reveal implicit or indirect dependencies. Large-scale software dependency structures are often extracted from source code using reverse engineering tools. However, it is recognized that direct syntactic dependencies are insufficient for understanding or analyzing software modular structure. And more precisely, logical or indirect, dependencies cannot be easily discovered from source code because, for example, critical design decisions may be implicit. Additionally, extracting dependencies from source code can only be accomplished in later states of the software development process.

### SUMMARY

An augmented constraint network (ACN) is described herein wherein dependency relationships can be determined without solving constraints. An ACN can be utilized to improve the ability to analyze the consequences of software design decisions and modular structures, at early stages of the software development process. An ACN models design decisions as first-class members and expresses how decisions make assumptions upon each other using logical constraints. Based on ACN modeling, the notion of a pairwise dependency relation (PWDR) among design decisions is formally defined. Also described herein are a number of design-level automated modularity and changeability analyses, such as design structure matrix (DSM) derivation and change impact analysis. In example embodiments, ACN modeling is used to formalize the information hiding principle and the notion of design rules. ACN also is used to automate and quantify changeability analysis, to quantitatively assess aspect oriented (AO) vs. object oriented (OO) design alternatives, and to check the modularity consistency between design structure and implementation structure.

Also described herein is a design rule hierarchy based on the assumption relations among design decisions. The modules within the same layer of the hierarchy suggest concurrent tasks. The dependencies between layers or within a module suggest possible need for communication. The hierarchy also manifests the influence scope of design decisions. The approach to automatically clustering software dependency structure into a design rule hierarchy (DRH) manifests definitions of module and design rules. In this hierarchy, the decisions within the top layer of the hierarchy are the most influential design rules, which dominate the rest of the system, and are kept stable. The decisions within subsequent layers assume design decisions in previous layers. The design decisions within each layer are clustered into modules. Since modules within the same layer are independent from each other, they become candidates for concurrent implementation.

### BRIEF DESCRIPTION OF THE DRAWINGS

FIG. 1 shows an example constraint network.

FIG. 2 shows the design automaton for a small graph library example.

FIG. 3 depicts dependencies in an example design structure matrix.

FIG. 4 is a flow diagram depicting an example process for implementing the dependency analysis algorithm.

FIG. 5 depicts the implication graph for an example ACN.

FIG. 6 shows a compatibility graph constructed from the implication graph in FIG. 5.

FIG. 7 shows the influence graph constructed from the implication graph in FIG. 5.

FIG. 8 shows a table depicting the running times used to process some ACNs.

FIG. 9 depicts an example UML class diagram of a small system for building a maze in a computer game.

FIG. 10 depicts an example design structure matrix of the maze game example, transformed from the UML class diagram shown in FIG. 9.

FIG. 11 shows part of the ACN derived from the UML diagram shown in FIG. 9.

FIG. 12(a) shows a partial maze game condensation graph generated from the maze game ACN.

FIG. 12(b) shows the hierarchy the BACN algorithm produces from FIG. 12(a) after aggregating these intersections into separate modules.

FIG. 13 contains example pseudo code of the BACN algorithm.

FIG. 14 shows a DSM of keyword in context with a modified hierarchy.

FIG. 15 shows a graph of the average and maximum number of dependencies for each layer of the DR hierarchy.

FIG. 16 show a table depicting the differences in proportion.

FIG. 17 is a block diagram of an example processor configured to appropriately implement and/or generate a design rule hierarchy, task parallelism, and/or dependency analysis.

### DETAILED DESCRIPTION OF ILLUSTRATIVE EMBODIMENTS

The augmented constraint network (ACN) models design decisions as first-class members and expresses how decisions make assumptions upon each other using logical constraints. Pairwise dependency relation (PWDR) among design decisions can be defined based on ACN modeling. A number of design-level automated modularity and changeability analyses are described, such as design structure matrix (DSM) derivation and change impact analysis. ACN modeling is utilized to formalize the information hiding principle and the notion of design rules. It also is utilized to automate and quantify changeability analysis, to quantitatively assess aspect oriented (AO) vs. object oriented (OO) design alternatives, and to check the modularity consistency between design structure and implementation structure.

ACN modeling focuses on expressing the assumption relations among decisions, and aims to reason about dependencies and modularity properties. Addressing the scalability issue in such a model can be advantageous because comprehension difficulty and modularity decay become prominent and relevant only when the software is of certain scale. The current approach of deriving pairwise dependency structure from ACN (i.e., the automatic derivation of design structure matrices) requires not only finding one satisfying solution to the constraint network but enumerating all the solutions, making the approach even harder to scale.

To make the model and the analysis techniques applicable to real software systems, some common characteristics possessed by the majority of existing ACN models were identified. These constraint-based formal models represent medium to large scale real software systems, and most of them can be automatically derived from prevailing software models, such as the unified modeling language (UML). Leveraging the formalized notion of design rules (stable dominating design decisions that decouple otherwise coupled subordinating decisions), developed is an approach to generating dependency relations from restricted, but highly representative, ACNs with O(n³) running time, reducing the complexity for these restricted formal models from NP-complete to polynomial.

The approach is based on the following observations. When investigating the dependency and hence modular structure of a software system, especially for large-scale software systems, it is determined whether one dimension makes assumptions about other dimensions, but not how. As a result, the variables in a software ACN often only has two values: “orig” to model a current decision, and “other” to model an unknown possible decision that is different from the current one. This simplification makes ACNs different from other formal models that detail the states of each component. Second, focus is placed on the assumption relation that can be expressed using logical implications. These characteristics allowed automatic derivation or the assumption dependency relation from UML class diagrams or component diagrams of real and large-scale software systems.

It is worth noting that the number of dependencies derived from an ACN transformed from a UML class diagram is much larger than the number of dependencies discovered from corresponding source code using reverse-engineering tools. For example, identified were 622 pairs of dependencies from a UML-transformed ACN for the Minos system (described in more detail below). While using Lattix (a reverse engineering tool), only 271 dependencies were identified. The majority of the differences are due to the fact that ACNs makes implicit and indirect dependencies explicit.

As described herein, focus is on addressing the scalability issue for large ACN models. To solve a constraint network with hundreds or thousands of variables is impractical. Nevertheless, software ACN models with this size often have the above two characteristics. Studied were 55 ACNs, acquired from published work or from on-going projects in modeling real software systems, that model multiple versions of heterogeneous software systems. Some of these ACNs were manually constructed, while others were automatically derived from other design models. Of these 55 ACNs, 53 of them shared the characteristics described above. The two remaining ACNs were of very small scale, with less than 20 variables. An ACN that exhibits these characteristics is called a binary augmented constraint network (BACN, pronounced bacon). Described herein is an algorithm to derive pairwise dependency relations for BACNs without solving the constraint network.

The evaluation aims to assess whether the approach can generate pairwise dependencies correctly, and whether it can be applied to real, large-scale software systems. Computed were dependence relations, hence the design structure matrices, from all ACNs available in literature, and also from ACNs automatically extracted from real, medium or large-scale software systems. Compared were the DSMs generated by the approach with published DSM models, and compared was the time needed to generate these DSMs using the new approach and existing approaches. It is shown that the DSMs are the same and the time needed often reduces from hours to seconds. The results show that this approach has the potential to make constraint-based design modeling and automated dependency analysis techniques applicable in real software systems.

Mathematical Formalization of ACN

Mathematical and theoretical basis are described. In particular, the augmented constraint network (ACN) and pairwise dependence relation (PWDR) are formalized. The small example ACN used also is used to illustrate our algorithm. In addition, a proof of the computational complexity for deciding PWDR is provided.

The augmented constraint network serves as a model for capturing design decisions and the assumptions among those decisions. An ACN comprises three parts: a finite-domain constraint network, a dominance relation, and a cluster set.

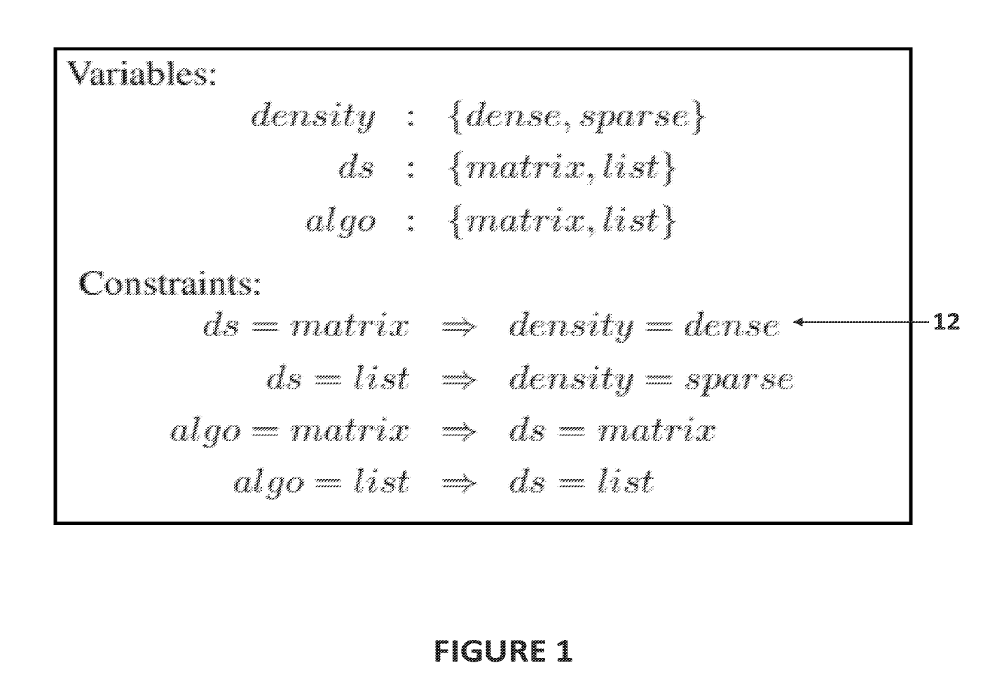

A constraint network is a tuple {V, U, d, C}, where V={v₁, v₂, . . . , vₙ} is a finite set of variables representing design dimensions where decisions are needed. Then d:V→2^{U} is a mapping of variables to a finite set of valid domain values. Hence, U is the universe of domain values for all variables. Lastly, C is a finite set of constraints upon the variables. FIG. 1 shows an example constraint network that models the design of a graph library. For example, the first constraint 12 says that the decision to use an adjacency matrix data structure (ds) assumes that the client needs dense graphs. The term binding is used to refer to specifying the value of a variable in a constraint (e.g., ds=matrix, density≠dense).

Dominance relation D⊂V×V models asymmetric dependence relations among decisions. Two dominance relation pairs for our graph example: (ds, density) and (algo, density) are defined. These pairs indicate that the decisions for what data structure and algorithm to use cannot influence the client's requirement on the density of graphs to be used. In other words, clients will not change the density of the graphs they use just because the library is designed with a certain data structure or algorithm.

Defined is a solution to a constraint network as a mapping s:V→U such that all variables are mapped to valid domain values ∀v∈V s(v)∈d(v) and all constraints are satisfied. Each solution to a constraint network is a valid design for the software modeled. For any constraint network, S is defined as the set of all its solutions. Given two solutions s, s′∈S, we use the notation s−s′ to represent the set of variables that are assigned different values by s and s′. Or formally, s−s′={v∈V|s(v)≠s′(v)}. We use the notation s\ s′ to represent the set of variables and values in s′, that are different from s. Formally, s\ s′={(v, u)∈V×U|s′(v)=u [symbol] s′(v)≠s(v)}. It is important to note that while s−s′ is commutative, s\s′ is not (i.e., s\s′≠s′\s).

From the constraint network and dominance relation, a non-deterministic finite automaton called a design automaton (DA) can be derived. The set of solutions S to the constraint network form the states of the DA, and each transition models a change in a design decision. Given an initial design s∈S, the transition function δ(s, v, u) denotes the valid designs resulting from changing variable v to domain value u in s. Since changing v to u may violate some constraints, the value of other variables may need to change to maintain a valid design. However, if a variable v′ must change to restore solution satisfiability but v′ dominates v (i.e., (v, v′)∈R, meaning that changes to v cannot force v′ to change), then such a change is considered invalid. In addition, transitions only show the destination states that differ minimally from the initial state. Formally, defined is δ(s,v,u)={s′∈S|s′(v)=u [symbol] ( [symbol] ∃s∈S\check{s}(v)=u [symbol] (s−\check{s})⊂(s−\check{s}) [symbol] (∀v′∈(s−s′)(v′, v)∉))}.

Regarding maintaining satisfiability through minimal perturbation from the concept of pairwise dependence relation (PWDR), PWDR can be defined as a set P∀V×V, such that if (u, v)∈P, meaning that v depends on u, then v must be changed in some minimal restoration of consistency to the constraint network, which was broken by a change in u. To formally define PWDR, first is defined a mapping Δ:S×V→2^{S} to be the set of states directly reachable from an initial states by changing a variable v to any valid domain value (i.e., Δ(s, v)=∪_{u∈d(v)\{s(v)}}δ(s, v, u)). From this, formally defined is the PWDR set P such that (v, v′)∈P if and only if ∃s, s′∈Ss′∈Δ(s, v) [symbol] v′∈(s−s′).

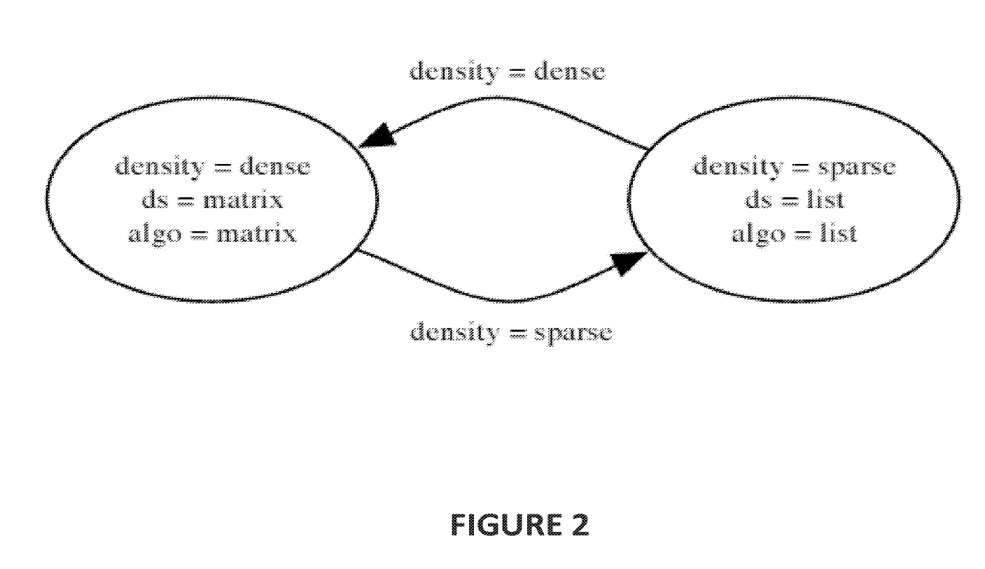

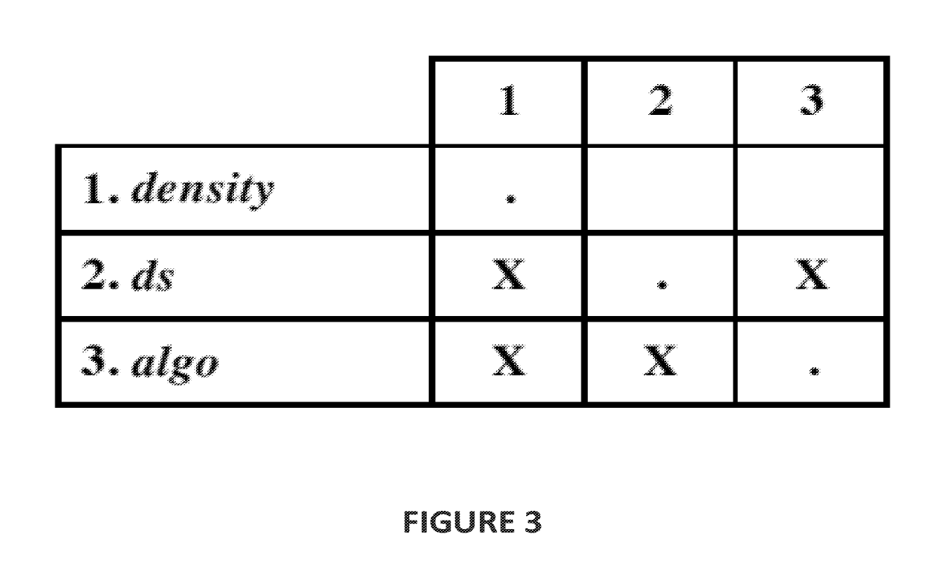

FIG. 2 shows the DA for the small graph library example. Since there are only two satisfying solutions to the constraint network, the DA contains only two states. For simplicity, the states are referred to as dense if (density=dense, ds=matrix, algo=matrix), and sparse if (density=sparse, ds=list, algo=list). There is only one valid transition from dense to sparse (by changing density to sparse) because changing either ds or algo would require changing density, which the dominance relation forbids. Since changing density to sparse requires changing both ds and algo to maintain satisfiability, both ds and algo are pairwise dependent on density. The marks in the first column of the design structure matrix (DSM) in FIG. 3 show these dependencies. In a design structure matrix, the columns and rows are labeled with design variables. A cell is marked if there is dependency between the decision on the row to the decision on the column. The remaining marks between algo and ds are due to the fact that every time one of them changes, the other does also.

Complexity of Dependency Analysis

The problem of deriving a pairwise dependency relation from a constraint network is NP-complete in general. This is proved by reduction from the constraint satisfaction problem (CSP). Given a finite set of variables V, a finite domain of values U′, and a finite set of constraints C′, the CSP problem is to decide whether there exists an assignment of domain values to variables that satisfy all the constraints. We reduce an instance of CSP to a PWDR decision problem: given an ACN and two variables a and b, decide whether there is a pairwise dependence (a, b).

From a CSP instance, constructed is an ACN instance by adding two additional variables V=V′∪{α, β}, two additional domain values ∪=U′∪{true, false}, and an additional constraint α=true [symbol] β=true. Since all variables from the CSP instance can be any domain value, we let ∀v∈V′d(v)=U. The domains of α and β are restricted to be only {true, false}. Hence, the added constraint guarantees that α and β will be assigned the same value in all solutions, and changing the value of α in any solution requires changing β to restore satisfiability.

There is a pairwise dependence (α, β) if and only if the CSP instance is satisfiable. Since C′⊂C, if there are no solutions to the CSP instance then there are no solutions to the ACN, and hence there is no pairwise dependence. It is easy to see that if there is a solution s to the CSP instance, then there are two corresponded solutions to the ACN, s₀ with α=β=false and s₁ with α=β=true. Since changing α also changes β, s₀ and s₁ and minimally different when changing α. Hence, if the CSP instance is satisfiable then (α, β) is a pairwise dependence. Therefore, computing PWDR is NP-Complete.

To address the scalability issue caused by constraint solving and solution enumeration, a divide-and-conquer algorithm to potentially reduce the number of solutions that need be processed at once splits an ACN into several smaller sub-ACNs that can be solved independently, then merges the DA from each sub-ACN to derive the full DA. Although this splitting technique does indeed reduce the total number of solutions explored and improves the performance from the initial brute-force algorithm, it does not change the problem complexity. The number of sub-ACNs that can be decomposed depends on the quality of design rules in the system. If a system is not well modularized, the divide-and-conquer algorithm will potentially generate sub-ACNs with large number of variables and solutions. Solving these large sub-ACNs and combining them together still exhibit exponential complexity.

The polynomial time algorithm (described in more detail below) does not require decomposing a large ACN and recomposing results from sub-ACNs, but applies only to ACNs with restricted forms described below. Further described below is a comparison of the running time needed for the new algorithm with the time needed for the divide-and conquer algorithm, showing that the new algorithm performs significantly better.

Binary Augmented Constraint Network

The approach is based on the observation that the majority of ACNs used to model real software systems exhibit two common characteristics that seem to be sufficient for dependency analysis. First, for dependency analysis, focus is on whether one decision makes assumptions on another decision, and whether changing the current decision will influence the decisions on other dimensions, rather than the current or changed decisions. As a result, the domain of a variable in an ACN often can be abstracted as having two values: orig (the current selected choice) and other (an unelaborated future choice). The rationale for this is that given a changed decision, the designer first needs to know what other dimensions will be impacted, but not what the exact new choices are. Modeling a software design this way will not be sufficient to support certain property analysis as supported by other model checking techniques, such as finding compatible states of all components. Instead, the focus is modularity and dependency analysis. Second, constraints in ACNs represent an assumption relation, which often can be expressed using the form a=α [symbol] b=β to mean that the choice for decision a assumes a certain choice for decision b.

An ACN that exhibits these characteristics is called as a binary augmented constraint network (BACN, pronounced bacon). More precisely, a BACN is an ACN where each variable has a binary domain and each constraint is a mathematical implication of two bindings a [symbol] b. Constraints of the form aνb and a [symbol] b can be trivially converted to the required form, so they are also considered valid in BACNs.

It is shown below that, unlike the general case of ACNs, computing PWDR for BACNs is not NP-Complete by presenting a polynomial time algorithm. The key to the tractability of this problem is that BACNs have both restricted constraint and domain arity. Any CSP can be transformed to one with only binary constraints, so only restricting the constraints does not change the problem complexity. Since each variable in a BACN has only two valid domain values, one of those values can be considered to be true and the other to be false, and the BACN becomes equivalent to a 2-CNF (conjunctive normal form) instance. A 2-CNF instance is a special case of the general Boolean satisfiability problem. A 2-CNF instance involves only constraints on no more than two variables, and each variable has only two values. In fact, the key is to consider the bindings as literals in a 2-CNF instance, and leverage existing 2-CNF techniques.

Since a BACN constraint network is equivalent to a 2-CNF instance, an algorithm for computing PWDR is to solve for all satisfying solutions and construct the design automaton. At first this may seem like a lucrative approach because it finds an initial satisfying solution, in linear time, and enumerates the remaining solutions, in polynomial time per solution. However, a state explosion problem exists because there are an exponential number of solutions in the worst case, making this approach infeasible for large models. In contrast, the BACN algorithm presented below does not enumerate all solutions and therefore its running time is independent of the number of solutions.

BACN Algorithm

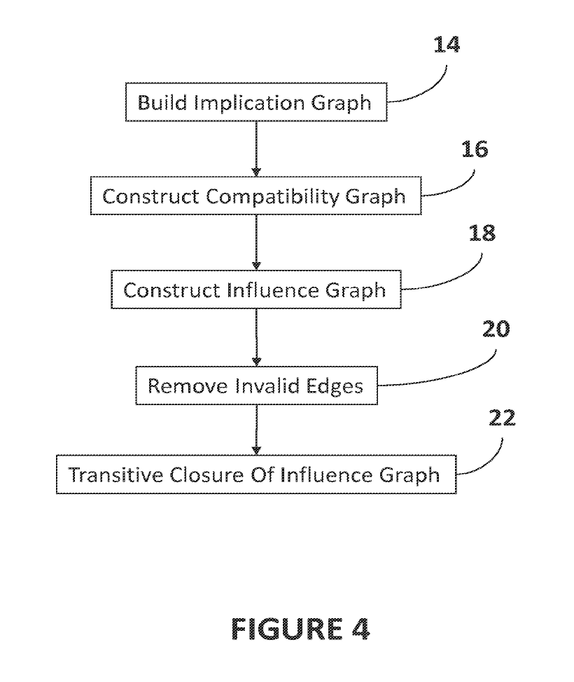

FIG. 4 is a flow diagram depicting an example process for implementing the dependency analysis algorithm. The example ACN from FIG. 1 is utilized to illustrate the BACN algorithm. The basic idea is to build an influence graph, whose edges are potential PWDR pairs; then use a compatibility graph of the constraint network to check for the existence of transitions in the DA, in order to verify the potential PWDR pairs. Both the influence graph and compatibility graph are constructed from an implication graph, a known structure for solving 2-CNF problems.

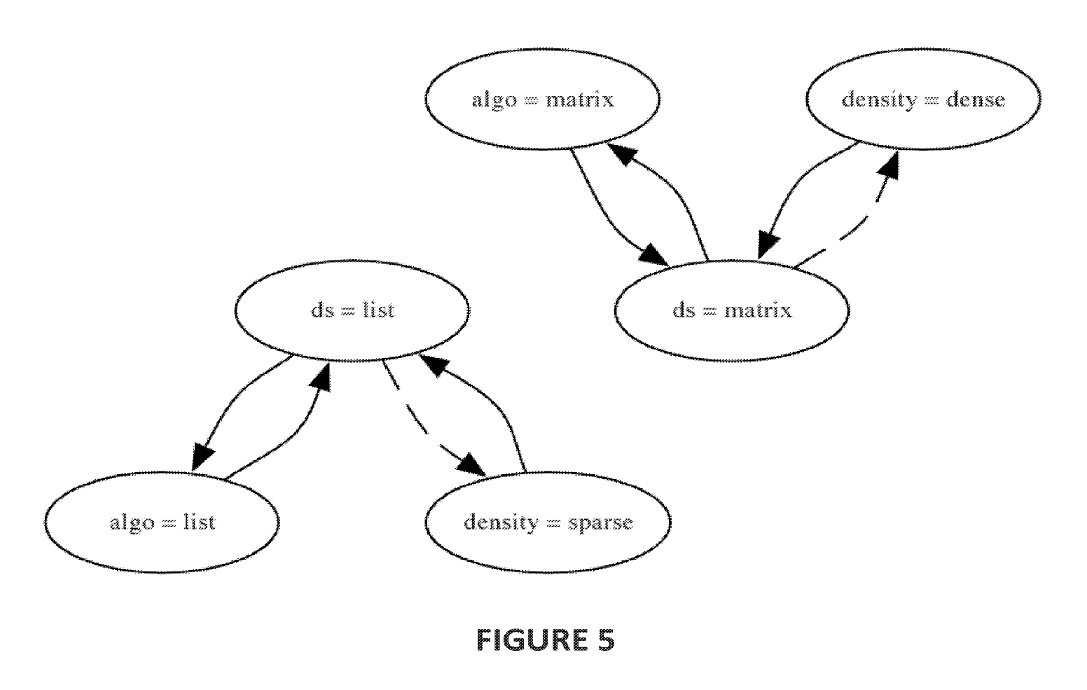

An implication graph is built at step 14. The implication graph is used to model the constraints. Two vertices are created in the implication graph for each variable in the constraint network: one for each domain value. For notational simplicity, the vertices are referred to (by their 2-CNF equivalents) as v and v̅ rather than by specific domain values. For each constraint u [symbol] v, two directed edges (u, v) and ( v̅, ū) are created. FIG. 5 shows the implication graph for the example ACN. For example, the edges (algo=matrix, ds=matrix) and (algo=list, ds=list) are created for the constraint: algo=matrix [symbol] ds=matrix. The significance of the dashed edges is described below.

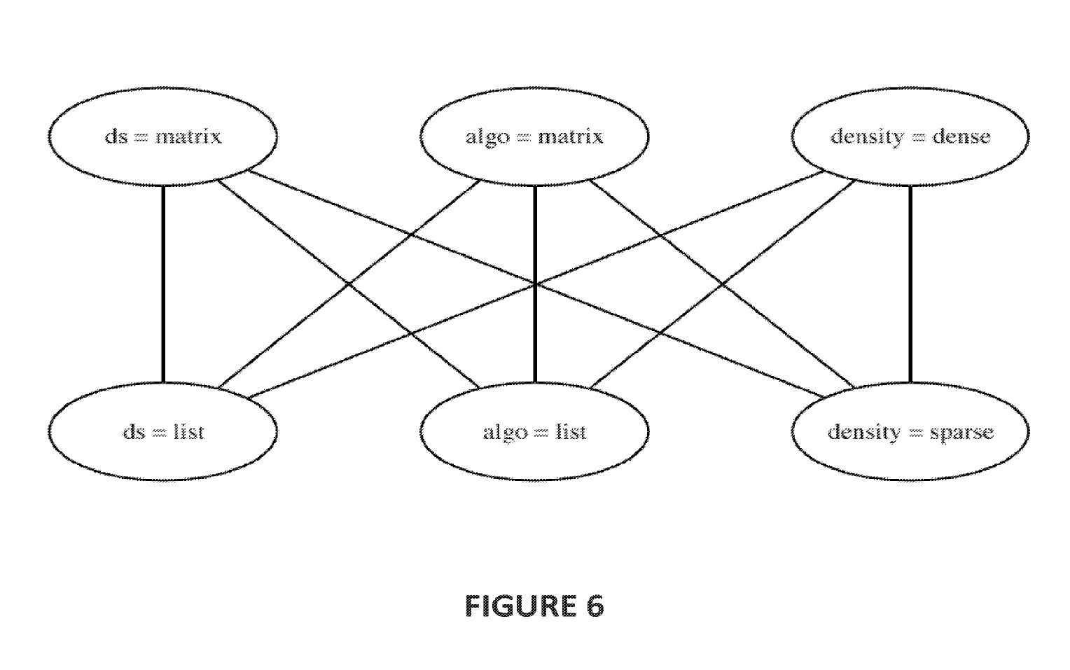

From the implication graph, a compatibility graph is constructed, at step 16, using an algorithm for identifying partial solutions to a 2-CNF instance. A compatibility graph is an undirected graph, with an edge (u, v) if and only if there is an edge (ū, v̅) in the transitive closure (the minimal transitive relation of the variables) of the implication graph (not shown). In other words, the edges in a compatibility graph represent the clauses (the disjunction of literals in a formula represented in conjunctive normal form (CNF)) in the transitively closed 2-CNF instance. FIG. 6 shows the compatibility graph constructed from the implication graph in FIG. 5.

Rather than identify all solutions to the constraint network and then finding dependent variables from transitions between solutions, the compatibility graph is used to identify partial solutions when checking for a potential dependency between variables. It has been shown that any valid vertex cover to the compatibility graph is a valid partial solution to the 2-CNF instance, and that minimal vertex covers are full solutions. Given a vertex cover S, if both v and v̅ are in the cover then v is unassigned in the partial solution; if only v∈S then v is assigned true, and if only v̅∈S then v is assigned false. For example, taking the top vertices in the graph in FIG. 6 clearly forms a valid vertex cover and logically is a valid solution/design because it uses adjacency matrices for dense graphs. Therefore, if one knows that changing a variable a, may require a change in b to compensate, then one can use the compatibility graph to confirm the existence of such partial solutions. A detailed example of this process is provided after defining the influence graph.

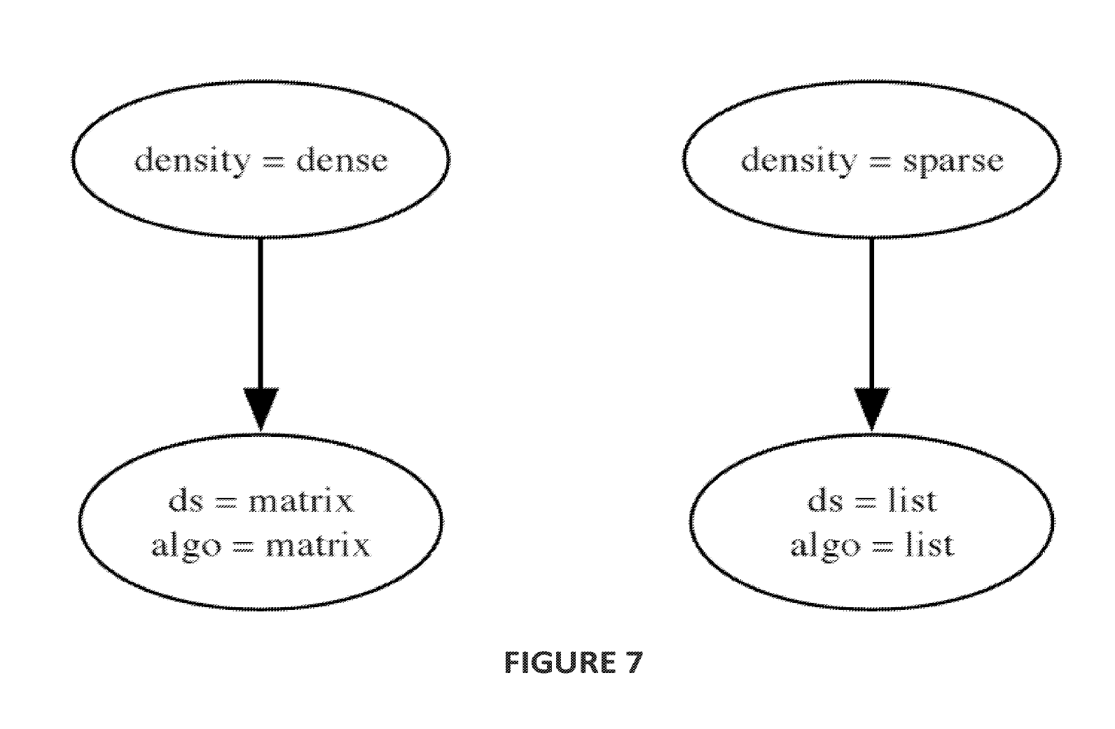

In order to account for the dominance relation and identify potential PWDR pairs, an influence graph is constructed, at step 18, from the implication graph. To construct the influence graph, the edges are removed, at step 20, from the implication graph corresponding to the dominance relations. If u cannot influence v (i.e.(u, v)∈D) the edges (u, v),(u, v̅),(ū,v) and (ū, v̅) are removed. The dashed edges in FIG. 5 show the edges that would be removed when constructing the influence graph for the example. Construction of the influence graph is completed by collapsing strong components into a single vertex, because all literals in a strong component will be assigned the same value in all solutions of a 2-CNF instance. FIG. 7 shows the influence graph constructed from the implication graph in FIG. 5. Since algo=matrix and ds=matrix form a strong component in the implication graph, they are merged in the influence graph.

Each edge (u, v) in the influence graph represents a constraint u [symbol] v from the ACN, so that if the value of u is changed to true then one may need to change the value of v to true in order to satisfy the constraint. Therefore, one can iterate through each edge (u, v) of the influence graph and use the compatibility graph to identify if v does indeed change to accommodate a change in u in any solution pair. Since edges were removed based on the dominance relation, not considered are any edge in which one is not allowed to change v in order to compensate for the change in u.

The edge ({density=dense}, {algo=matrix, ds=matrix}) from FIG. 7 is used to illustrate this dependence analysis process. Since algo=matrix and ds=matrix will be always have the same value, algo=matrix is arbitrarily picked for checking the compatibility graph. Only algo and density are considered, so both vertices for ds are always in the vertex cover. If the potential vertex cover is S={algo=matrix, density=dense, . . . } (i.e., both vertices from the influence graph set as true), then vertex cover is valid because there is no edge between algo=list and density=sparse in the compatibility graph. Changing the value of density, one would need to complement algo to restore satisfiability and look at S′={algo=list, density=sparse, . . . }. Since S′ is also a valid vertex cover, the algo changes to compensate for the change in density.

Sometimes changing a variable u may cause the constraint to be unsatisfied but there is no way to restore consistency. In such situations, there will be no valid pair of valid vertex covers where both u and v are different values. This scenario can occur when there is a self-loop in the compatibility graph and hence, a variable remains the same value in all solutions. When such a scenario occurs, such an edge is said to be invalid and it is removed from the influence graph since it cannot be a PWDR pair.

After removing the invalid edges from the influence graph (at step 20), the PWDR can be determined, at step 22, from the transitive closure of the resulting influence graph. The reason the transitive closure is taken is because changing a variable may cause a ripple effect. For example, consider the constraints a [symbol] b and b [symbol] c. If all variables start as false, and one change a to true, then b needs to change to true to satisfy the first constraint. But changing b to true causes c to change to true to satisfy the second constraint. Since all variables in a strong component are always the same, they are all pairwise dependent. Finally, the set of edges of the transitively closed influence graph make up the rest of the PWDR pairs.

Complexity Analysis

The running time complexity of the BACN algorithm is described herein. For notation purposes, let n be the number of variables and m be the number of constraints in the ACN. The BACN algorithm comprises the following steps and running times:
1) Construct implication graph (step 14 of FIG. 4): O(n+m)
2) Construct compatibility graph (step 16 of FIG. 4): O(n³)
   a) Transitive closure of implication graph: O(n³)
   b) Populate edges: O(n²)
3) Construct influence graph (step 18 of FIG. 4): O(n+m)a) Remove dominance relation edges: O(m)b) Find strong components: O(n+m)
4) Remove invalid edges (step 20 of FIG. 4): O(m) Since one needs to consider only a constant number of edges to verify a valid vertex cover, a constant amount of time was spent per edge.
5) Transitive closure of influence graph (step 22 of FIG. 4): O(n³) Since m≦n², the total running time of the BACN algorithm is O(n³) polynomial. In addition, three graphs were constructed, each with 2n vertices and at most 2m edges, so the BACN algorithm also uses polynomial space.

Evaluation

Given that the purpose was to extract dependency structures, which can be represented using design structure matrices, the evaluation focused on the effectiveness of generating DSMs from ACNs. DSM itself has shown to be an effective modularity analysis and visualization model. The correctness of the BACN algorithm was evaluated by comparing the DSMs automatically generated from the new algorithm with those generated using the divide- and conquer approach. The performance of both algorithms was compared in terms of the time needed to generate DSMs from the same set of ACNs. The largest ACN the divide-and-conquer approach can handle, that is, generating DSMs within reasonable time and without running out memory, has less than 130 variables. To evaluate whether the new algorithm can handle much larger models, the BACN algorithm was applied to ACNs that model real, large-scale open source projects. Described below is the environment used for comparing the BACN algorithms, the subject software systems, and the experimental results, highlighting several real software systems that were investigated.

Environment

The experiments used a system referred to as Minos. Minos allows a user to build ACN models and generate DSMs, One improvement of Minos over existing techniques is the plugin architecture to support easy feature extension. As a result, both the BACN algorithm and the divide-and-conquer algorithm are implemented in Minos as interchangeable components.

The experiments ran on a Linux server with two quad-core 1.6 GHz Intel Xeon processors and 4 GB of RAM. Minos's implementation of the divide-and-conquer PWDR algorithm also optimizes the running time by parallelizing the construction of DAs using multiple threads. It was found, through experimentation, that using four threads in Minos produced the peak performance for the BACN algorithm on the machine used. The brute-force algorithm simply enumerated all solutions to the ACN to build a DA, and identified PWDR from the DA transitions. Since this brute-force approach is extremely hard to scale, it was not used to perform the comparison.

Subjects

55 ACNs were studied in total, modeling both small but canonical software examples widely used in software engineering literature, and medium to large-scale real software systems. Concretely, for small canonical examples, 2 ACNs were studied representing two variations of the keyword in context (KWIC) system, 7 ACNs representing different variations of the widely used Figure Editor (FE) example, including AO and OO alternatives for multiple features, and a MazeGame illustrating design patterns. All these ACNs are also BACNs except for the two KWIC models.

ACNs that model real software systems were also studied, including 10 ACNs modeling variations of the WinerySearch system, 6 ACNs abstracting from a fault tree analysis tool called Galileo, 3 ACNs modeling the AO, OO, and DR alternatives of a networking system called HyperCast, 2 ACNs modeling two versions of a financial management system called Vodka, and 16 ACNs modeling 8 releases of a software product line called MobileMedia, with AO and OO alternatives for each release. The ACNs represent heterogeneous real software systems. The commonality among these ACNs is that they are all derived from higher-level software artifacts than source code. The MobileMedia ACNs were automatically generated from UML component diagrams, all other ACNs were manually constructed from specifications and design descriptions. All these 37 ACNs are also BACNs, showing that BACN is a highly representative form.

All the above ACNs that have been studied in existing literature, have relatively small scale—although the underlying software system may not be small due to different granularity of abstractions. For example, Galileo has about 35 KLOC (thousand lines of code) of C++, but most ACNs only abstract part of it using about a dozen variables. So the Galileo ACNs were not counted as representative models.

One purpose was to test whether the BACN algorithm could enable dependency derivation from large-scale models. However, the largest ACN model of the above two categories had only 81 variables and there was no large-scale design-level artifacts to transform into ACNs. To test the scalability of the approach, the strategy was to take a real software system of reasonable scale, reverse engineer it into a UML class diagram, and then derive an ACN from the UML class diagram. As previously described, significantly larger number of dependencies, mainly implicit or indirect dependencies, can be picked up by this technique than using traditional reverse engineering tools to extract syntactical dependencies. The subjects selected included the first and second versions of Hadoop, and Minos itself. Using Minos to generate a DSM modeling itself provided a way to assess scalability and modularity of its own. The ACNs generated for these systems all had hundreds of variables, and were all BACNs.

Results

The results of running the BACN algorithm and the comparison against the results of the divide-and-conquer algorithm are described below. Given an input ACN, a corresponding DSM using each algorithm was computed, and an answer the following evaluation questions was obtained through the comparison: (1) does the BACN algorithm produce the same DSMs as the divide-and-conquer algorithm; and (2) does the BACN algorithm outperform the divide-and-conquer algorithm, in terms of running time?

To answer the first question, all the DSMs generated from BACNs were compared using the BACN algorithm with the DSMs generated using their algorithm. First of all, not all DSMs can be generated using the divide-and-conquer approach because some decomposed sub-ACNs are still too large to be solved within reasonable time without running out of memory. For all the ACNs that can be processed by both algorithms, the DSMs generated were exactly the same, providing a positive answer to the first question.

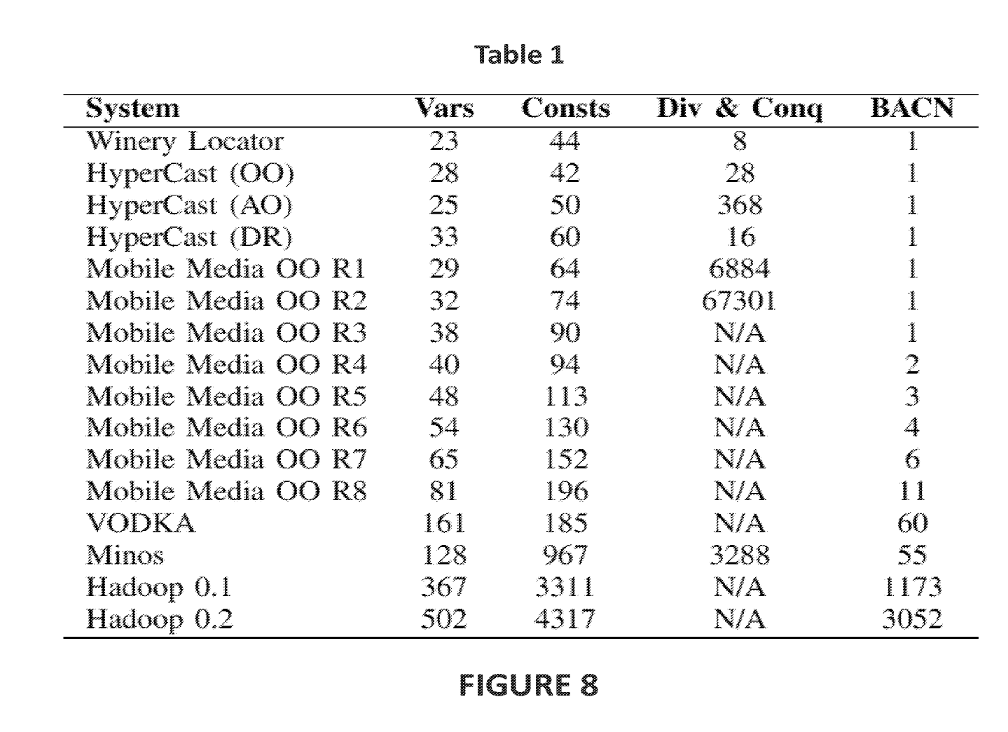

To answer the second question, FIG. 8 shows a table, Table 1, depicting the running times used to process some of the ACNs. All 53 results are not listed because some of the ACNs are too small, and also because ACNs representing different alternatives of the same system did not differ much in terms of scale. For example, only 1 of 10 Winery Locator ACNs is shown to represent this system.

In Table 1, the first column shows the name of the software; the second column shows the number of variables in the ACN; the third column shows the number of constraints in the ACN; the fourth column shows the running time of the divide-and-conquer algorithm; and the fifth column shows the running time, in seconds, of the BACN algorithm. All algorithm running times are reported in seconds. “N/A” is used to denote when an algorithm cannot compute the PWDR set due to memory exhaustion. The results for several of the larger real systems are described below.

HyperCast. HyperCast is a scalable, self-organizing overlay system developed in Java, with roughly 50 KLOC. HyperCast has been studied in multiple software engineering works for different purposes. Investigated were three different designs of the system (one using object-oriented programming, one using oblivious aspect-oriented programming, and one using design rules and aspect-oriented programming). The DSMs described herein were manually constructed. ACNs were used to automatically generate these DSMs, and fix several errors caused by manual construction in the previous work. The conformance between design and implementation of HyperCast was checked.

Table 1 shows that for all three designs of HyperCast, the BACN algorithm produced the same DSM and finished faster than the divide-and-conquer algorithm. For example, the divide-and-conquer algorithm took over six minutes to generate the DSM for the AO design of HyperCast, but the BACN algorithm only took one second.

MobileMedia. The BACN algorithm was evaluated over eight releases of a software product line called MobileMedia. MobileMedia contains about 3 KLOC and provides support for handling photo, music, and video data on mobile devices, such as cellular phones. Each release evolves from the previous release by adding some new functionality or by restructuring the previous release to achieve a better modularized structure. Although two designs and implementations of MobileMedia exist (one with object-oriented programming and one with aspect-oriented programming), only the running times for the OO versions are shown in Table 1.

Table 1 shows that the divide-and-conquer algorithm not only took dramatically more time than the BACN algorithm, but often could not complete computation. The divide-and-conquer algorithm took almost 2 hours to process release one and almost 19 hours to process release two, despite the fact that only three additional variables were added to the design. On the other hand, the BACN algorithm reduced these running times to just over one second, with a negligible increase in running time. This substantial increase in running time of their algorithm is due to the fact that the number of solutions to a constraint network can be exponential to the number of variables, and emphasizes the need for an algorithm whose performance does not depend on solution count.

After release two, the MobileMedia constraint networks have so many solutions that the divide-and-conquer algorithm can no longer enumerate all solutions with the amount of memory available on the test machine. This scenario of memory exhaustion is described below. Since the BACN algorithm does not depend on the number of solutions, the DSMs for all eight releases were able to be computed.

A web-based, service-oriented software system, VODKA Organizational Device for Keeping Assets (VODKA), used to standardize the financial management simplify auditing, contains 154 functional requirements, 11 non-functional requirements, 20 web services, and 13 Java servlets. The entire system (including requirements, architecture/design, and test procedures) was modeled with ACNs.

As Table 1 shows, the divide-and-conquer algorithm could not compute the DSM for VODKA. After running for almost two hours, Minos crashed with an out of memory error. Some debugging code was added to Minos to report its progress when crashing and it was found that even with the ACN splitting technique, one of the sub-ACNs contained over 1.1 million solutions. Minos was executed on a machine with 8 GB of memory to see how long it would take to actually derive the DSM for VODKA, but after running for 49 hours and using 7.5 GB of memory it was still not finished finding all the solutions. In contrast, without any splitting of ACNs, the BACN algorithm was able to compute the DSM within one minute.

Minos is a framework for ACN and DSM analysis. It is written in Java with a flexible plugin architecture to allow for ease of adding new analyses and replacing existing analyses. A UML class diagram was reverse engineered from the Minos code base (10 KLOC) and an ACN was automatically derived from it.

By examining a breakdown of the running time of the divide-and-conquer algorithm on the Minos ACN, the tradeoffs of the divide-and-conquer approach were clearly seen. The divide-and-conquer algorithm divided Minos into 57 sub-ACNs. Most of these sub-ACNs had few solutions (minimum was 3) and very few sub-ACNs had a large number of solutions (maximum was 23,041), thus the total time for finding all the solutions to the sub-ACNs was about 20 seconds. On the other hand, finding the transitions of the DA took almost half the time (24 minutes) and merging the DAs took almost the rest of the time (20 minutes). Hence, it is seen that although using a divide-and-conquer approach reduces the time to solve the constraint network, it introduces additional time to merge the DAs together. Since the BACN algorithm does not take any of these steps, the running time is reduced from 55 minutes to 55 seconds.

The largest system used to evaluate the approach was Hadoop. Hadoop is an open source map/reduce system for distributed computing, written in the Java programming language. UML class diagrams were reverse engineered from the first two releases of Hadoop and ACNs were automatically derived from them. Release 0.1 contained 197 classes and interfaces, and release 0.2 contained 269 classes and interfaces.

Due to the number of solutions to the constraint network, the divide-and-conquer algorithm could not produce a DSM on the test machine. The BACN algorithm took about 19 minutes to process version 0.1 and 50 minutes to process version 0.2. The time needed to process Hadoop 0.2 took the longest time in the evaluation. As described below, by leveraging existing work on computing transitive closure, it is possible to improve the BACN algorithm and further reduce the running time complexity. At this point, it is clear that generating DSMs from a formal model of this size is possible. It also is noted that the time for the divide-and-conquer algorithms to report that they failed was longer than the time for the BACN algorithm to complete.

In summary, 53 BACNs were used to compare the performance of the BACN algorithm with an existing algorithm and answered the two previously described evaluation questions (Does the BACN algorithm produce the same DSMs as the divide-and-conquer algorithm? And, does the BACN algorithm outperform the divide-and-conquer algorithm, in terms of running time?). For all the BACNs, the answer to the first question is in the affirmative (yes). That is, the BACN algorithm computes the correct DSMs, consistent with those produced by the divide-and-conquer algorithm. The answer to the second question also is in the affirmative (yes). That is, the BACN algorithm outperforms the divide-and-conquer algorithm for all the studied BACNs. In many cases, the memory requirements to enumerate all solutions of the constraint network prevents the divide-and-conquer algorithm from successfully completing. Since our algorithm's running time (and memory use) does not depend on the number of solutions, our algorithm was able to correctly derive DSMs for all the BACNs, often reducing the running time from hours to seconds from the previous algorithms.

It is worth noting that whether the divide-and-conquer approach will work does not depend only on the number of variables. For example, the divide-and-conquer algorithm cannot generate the DSM for MobileMedia release 4 with only 40 variables, but can generate a DSM for Minos that has 128 variables. This is due to the fact that Minos is well modularized and its DRs, formalized as dominance relations, decompose the large-ACNs into much smaller sub-ACNs.

Another possible way to evaluate the BACN algorithm is to perform the running time comparison using input ACNs randomly generated from a uniform distribution. It was decided not to evaluate the BACN algorithm this way but rather to use ACNs modeling real software designs because ACNs that the BACN algorithm will encounter in practice may not be uniformly distributed in the problem space. In other words, although an algorithm may have high probability of being efficient for any randomly selected input, the inputs it will be given in practice may be exclusively from the subset where it performs poorly. Table 1 supports this idea that real ACNs are from a non-uniform distribution because all the ACNs found had relatively few constraints (compared to the maximum number of possible constraints). Instead, ACNs modeling multiple heterogeneous real software designs were selected as inputs for the evaluation.

It is believed that optimization can be performed on the BACN algorithm to improve its performance. The relation between variables and constraints in Table 1 provides insight into one possible way. Since the number of constraints m is much less than the number variables squared m<<n², these graphs are sparse so more efficient graph algorithms may improve the BACN algorithm's running time. For example, the most expensive parts of the BACN algorithm are computing the transitive closure for the implication graph and influence graph. Using one approach, it takes us O(n³) to compute transitive closures of these graphs, but another approach could offer an improvement to O(n² log n+nm).

Another possible direction for optimization is to use multiple threads to parallelize parts of the BACN algorithm. Minos's implementation of the divide-and-conquer algorithm also uses multiple threads as a way of optimization. One area we are exploring is to parallelize the computation of transitive closures.

As previously described, the approach picked up a lot more indirect and implicit dependencies that were not revealed by traditional reverse-engineering based dependency extraction methods. These extra dependencies can improve the ability to predict change impact and communication requirements. However, the approach described herein addresses the scalability issue in the problem of extracting dependency from large-scale formal models without solving the constraints.

Unlike many other formal modeling languages, ACNs are designed specifically for analysis of dependencies and software modular structure, based on assumptions among design decisions. In addition to their differences in terms of purposes, ACNs also differ in that they formalize the notion of design rules from a modularity theory, and enable automated DSM derivation, changeability analysis, design modularity and stability measurement.

General PWDR algorithms suffer from a state explosion problem, similar to many model checking algorithms. The ACNs evaluated often could not be processed by the divide-and-conquer algorithm due to the exceedingly large demand for memory to enumerate all solutions to the constraint network.

To address the problem that the current approach of generating dependency structure from logical constraint models is hard to scale due to the needs of constraint solving and solution enumeration, an algorithm that applies to a restricted but representative form of ACNs, thus reducing the complexity from NP-complete to polynomial time, is described herein. The approach was evaluated by generating DSMs from existing ACNs modeling heterogeneous software systems, and comparing the DSM generated and time needed with that of a previous divide-and-conquer algorithm. The results showed that the new algorithm can generate DSMs for much larger models using significantly less time, making it possible to conduct dependency analysis for real software systems.

Design Rule Hierarchy

As previously mentioned, a design rule hierarchy (DRH) is based on the assumption relations among design decisions. The modules within the same layer of the DRH suggest concurrent tasks. The dependencies between layers or within a module suggest possible need for communication. The DRH also manifests the influence scope of design decisions. The approach to automatically clustering software dependency structure into a DRH manifests definitions of module and design rules. In this DRH, the decisions within the top layer of the DRH are the most influential design rules, which dominate the rest of the system, and are kept stable. The decisions within subsequent layers assume design decisions in previous layers. The design decisions within each layer are clustered into modules. Since modules within the same layer are independent from each other, they become candidates for concurrent implementation.

This DRH, populated with sufficient dependency relations, can shed light on the interplay between software structure, task parallelism, and developers' coordination needs. Concretely, the DRH predicts that developers working on different modules within the same layer do not have communication requirements; whereas dependencies between modules located in different layers, or within the same module, create communication requirements among developers working in those contexts.

The accuracy of the DRH predictions on coordination requirements fundamentally depends on the quality of the underlying model of software dependency. For example, syntactical dependencies extracted from source code are not as effective as semantic relationships in terms of individuating coordination requirements. An approach to precisely define and automatically derive pair-wise dependency relations (PWDR) from a formal model is called the augmented constraint network (ACN). An ACN expresses design decisions as variables, models how those decisions make assumptions about each other using logical constraints, and complements the constraint network with a dominance relation that formalizes the concept of design rules.

As described herein, a pair-wise dependency relation (PWDR) derived from an ACN is used as the basis to form the design rule hierarchy (DRH). Its efficiency is described herein. The PWDR can be used to automatically derive a design structure matrix (DSM) with rigorous semantics. A tool has been developed, called Minos, to support ACN modeling and a number of modularity analysis, including automatic DSM derivation.

The effectiveness of the DRH is evaluated, in terms of predicting parallel task assignments and manifesting impact scope of design rules, by postulating the following hypotheses: first, developers working on different modules within the same DRH layer engage in technical communication substantially less than other groups of developers. Second, on the contrary, the need for technical communication is particularly strong for those developers that work on modules that have cross-layer dependencies. Third, the position of a design rule in the hierarchy reflects its importance in the system, with the decisions at the top level being the most influential on the overall system design.

To test the first two hypotheses, the evaluation is organized around the mining of publicly available archives and repositories of an open source project, Apache Ant version 1.6.5. The source code was reverse engineered into a UML class diagram and the UML model was transformed into an ACN, from which a DRH is derived to predict coordination structure.

Although the ACN is indirectly transformed from source code, the number of dependencies derived from the ACN is much larger than the number of dependency pairs directly discovered from source code using a reverse engineering tool such as Lattix. From Apache Ant ACN, 12,596 dependencies were derived, while the dependencies shown in Lattix have only 1,700 pairs. The differences are caused by indirect and implicit dependencies picked up by the constraint network. Furthermore, the developers' mailing list and the version control repository of the project during the period leading to the following release, v.1.7.0, were mined to infer concurrent development tasks and related communications between developers.

Through statistical analysis, the first two hypotheses are shown to be true: developers working on different modules within the same layer of the DRH communicate significantly less than other groups; the majority of communications happens instead between developers working on dependent modules located in different layers.

To test the third hypothesis, a DRH was similarly generated for Minos itself. It was determined whether the hierarchy reveals correctly the importance of its design rules. Again, the hypothesis is supported, for example: the top layer of the Minos DRH contains the most influential decisions of the system.

Illustrative Models

In this section, a small example is used to illustrate three models that facilitate an understanding of the techniques described herein: the unified modeling language (UML), design structure matrix (DSM), and augmented constraint network (ACN).

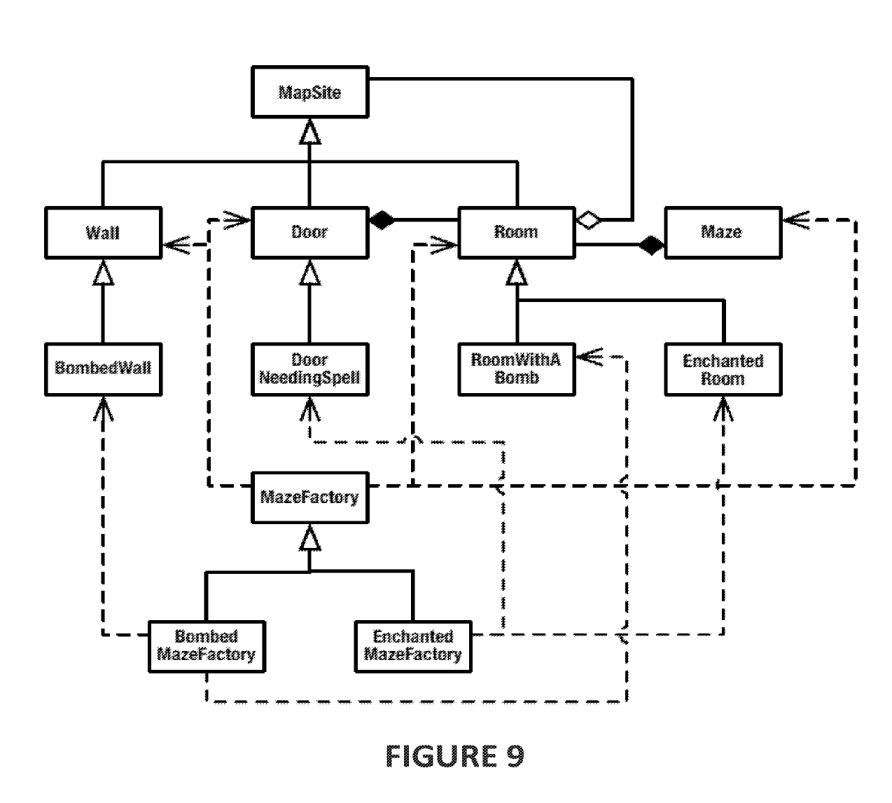

The Unified Modeling Language (UML) as depicted in FIG. 9 shows a UML class diagram of a small system for building a maze in a computer game; this system uses the abstract factory pattern. A maze is defined as a set of rooms; a room knows its neighbors, such as a wall, or a door to another room. The class MapSite is the common abstract class for all the components of the maze. The UML class diagram shows two variations of the maze game supported by the abstract factory pattern: (1) an enchanted maze game (EnchantedMazeFactory) with a door that can only be opened and locked with a spell (DoorNeedingSpell), and a room that has a magic key (EnchantedRoom); (2) a bombed maze game (BombedMazeFactory) that contains a room with bomb set in it (RoomWithABomb) and a wall that can be damaged if a bomb goes off (BombedWall).

From a UML class diagram, it is not easy to determine concurrent tasks, that is, modules that can be developed in parallel. For example, if a team is assigned the task of implementing the enchanted maze game, the team has to examine the diagram to determine all the classes that have to be developed. In addition, they must be aware of other classes, such as MapSite, that the enchanted maze game components must interact with. These classes may be designed by other colleagues, creating dependencies between tasks. In addition, UML models can scale to the extent when tracing the relations among the classes to determine these dependencies becomes difficult.

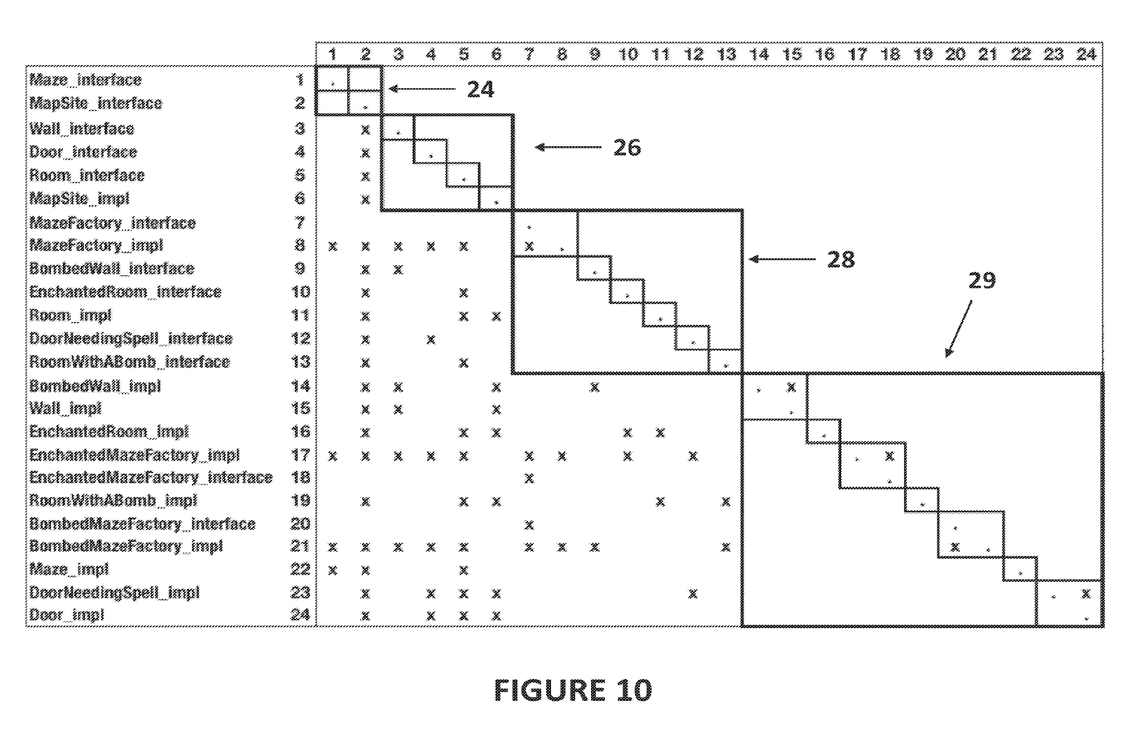

The Design Structure Matrix (DSM) and Design Rule Theory as depicted in FIG. 10 show a design structure matrix (DSM) of the maze game example, transformed from the UML class diagram shown in FIG. 9. A DSM is a square matrix in which rows and columns are labeled with design dimensions where decisions are made; a marked cell models that the decision on the row depends on the column. In this DSM, each class is modeled using two design variables: an interface variable and an implementation variable. For example, the cell in row 11, column 2 indicates that the implementation of the Room class (Room_impl) depends on the interface of the MapSite class (MapSite_interface).

Building on DSM models, design rules are utilized as stable design decisions that decouple otherwise coupled design decisions, hiding the details of other components. Examples of design rules in software include abstract interfaces, application programming interfaces (APIs) that decouple an application from a library, a data format agreed among development teams, and even naming conventions. Broadly speaking, all the non-private parts of a class that are used by other classes can be seen as design rules.

DSM modeling can capture the concept of modules and design rules, as well as their decoupling effects. Modules are represented as blocks along the diagonal and design rules are captured by asymmetric dependencies that decouple modules. For example, the Room_impl variable influences both BombedRoom_impl and EnchantedRoom_impl, but is not influenced by them. Therefore, once the common room characteristics are implemented by the parent Room class, the BombedRoom_impl and EnchantedRoom_impl only need to implement their own special features; they need not know the existence of each other. As a result, the Room_impl serves as a design rule that decouples the implementations of EnchantedRoom and BombedRoom.

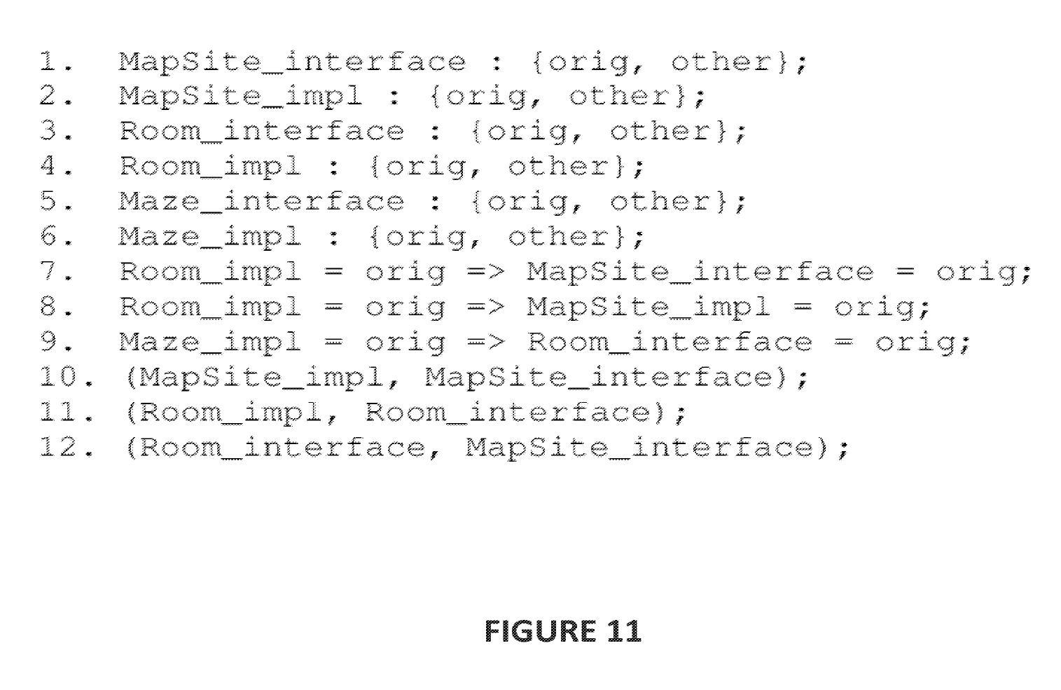

The augmented constraint network (ACN) formalizes the concept of design rules and enables automatic DSM derivation. FIG. 11 shows part of the ACN derived from the UML diagram shown in FIG. 9, and FIG. 10 shows the DSM model that is automatically derived from the ACN. An ACN comprises a constraint network that models design decisions and their assumption relations, a dominance relation that formalizes the design rule, and a cluster set in which each cluster represents a different way to partition a design.

A constraint network comprises a set of design variables, which model design dimensions or relevant environment conditions, and their domains; and a set of logical constraints, which model the relations among variables. In FIG. 11, lines 1-6 are some variables from the maze game, and lines 7-9 are some sample constraints. For example, line 9 models that the implementation of the Maze class assumes that the interface of the Room class is as originally agreed.

The constraint network is augmented with a binary dominance relation to model asymmetric dependence relations among decisions, the essence of design rules, as shown in lines 10-12. For example, line 11 indicates that the decision for how to implement the Room class cannot influence the design of its interface; in other words, we cannot arbitrarily change the Room class's interface to simplify the class's implementation because other components may rely on it.

From the constraint network and the dominance relation, formally defined is a pairwise dependence relation (PWDR): if (x, y)∈PWDR then y must be changed in some minimal restoration of consistency to the constraint network which was broken by a change in x. A DSM can be automatically derived from an ACN where the matrix is populated by the PWDR and the columns and rows are ordered by a selected clustering.

DSMs described herein are generated from ACNs that are automatically transformed from UML class diagrams. The automatic DSM derivation from ACN is supported by Minos. And, described in detail below are clustering methods to reveal design rules and independent tasks.

Approach Overview

In this section, the maze game example is used to introduce the design rule hierarchy that reveals design rules and independent modules, and to illustrate how the hierarchy is derived from an ACN.

Design Rule (DR) Hierarchy

The DSM shown in FIG. 10 is clustered into a four-layer design rule (DR) hierarchy. The four outer groupings in FIG. 10 show the layers in which tasks can be completed in parallel; each module within a layer depends only on the decisions within the layers to the left of it in the DSM. Because there are no inter-module dependencies within each layer, the modules can be assigned as concurrent tasks.

In an example embodiment, the first layer 24 identifies design rules that are most influential and should remain stable. In FIG. 10, the first layer 24 comprises the variables Maze_interface and Map-Site_interface. In this example, changing these design rules can have drastic effects on a system. For example, changing a public method signature in the MapSite class may require changes to almost all parts of the software (as shown by the numerous marks under column 2).

The second layer 26, from row 3 to row 6, contains decisions that depend on the top layer decisions. Similarly, the third layer 28, from row 7 to row 13, contains decisions that make assumption about decisions made in the first two layers. Each inner cluster within a layer contains decisions that should be made together, such as the MazeFactory_interface (row 7) and MazeFactory_impl (row 8) decisions. The decisions made in an inner cluster can be made at the same time with other inner cluster decisions within the same layers. For example, although MazeFactory_interface and DoorNeeding-Spell_interface do not belong to the same layer of an inheritance hierarchy, they are in the same DR hierarchy layer because once the DRs in the previous layer are determined, these decisions can be developed concurrently.

The last layer 29 of the hierarchy identifies independent modules. Not only can these modules be designed and developed concurrently with each other, but they can also be swapped out for different implementations without affecting the rest of the system. For example, although Wall_impl is a parent class, it does not decouple other modules, and is only used by the BombedWall_impl. As a result, Wall_impl is not a design rule in the current system, and the developers of these two classes can work together for a better Wall implementation without worrying about unwanted side effects.

DR Hierarchy Clustering

To compute a DR hierarchy, all decisions needed for each task are identified. Then which of these decisions are shared by other tasks and which can be made independently and concurrently are identified.

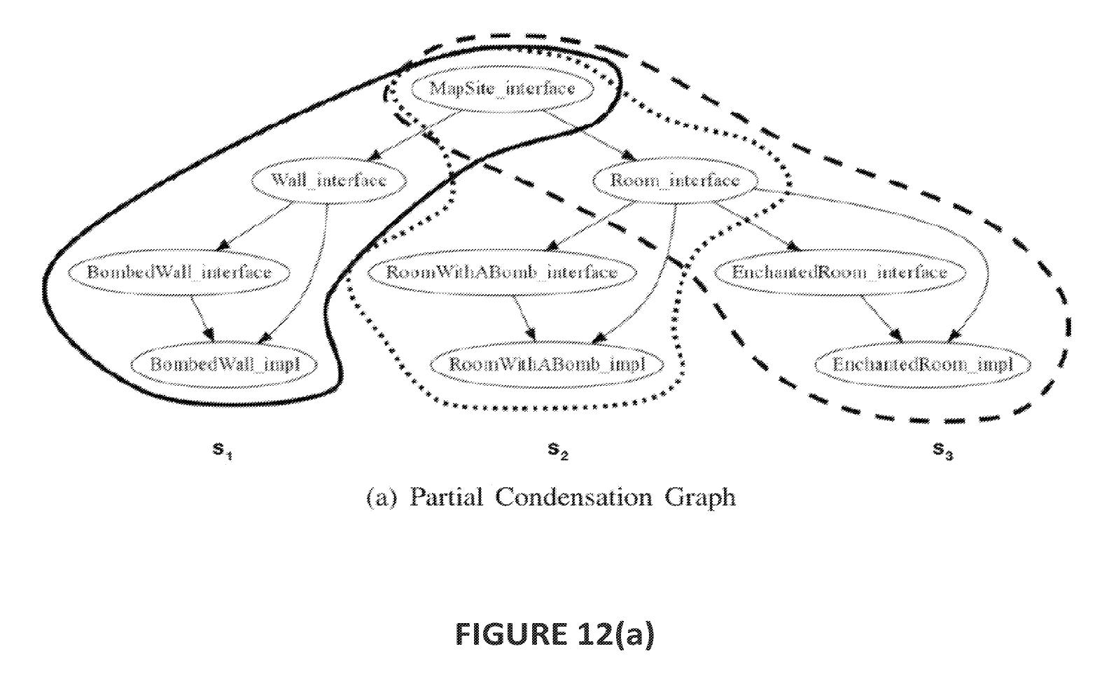

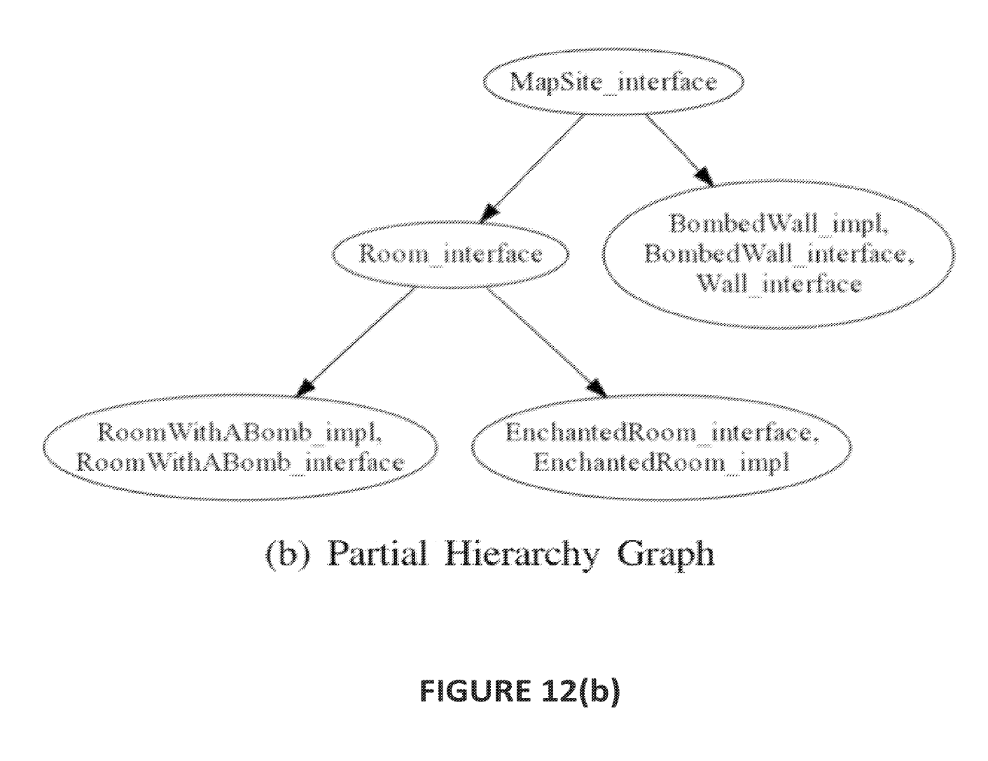

The first step to identify decisions needed by a task decomposes an ACN into a set of sub-ACNs. Each sub-ACN contains the set of decisions needed to accomplish a particular task. This is referred to as the Decompose-Modules algorithm. The basic idea is to model the constraint network as a directed graph. In this graph, each vertex represents a design variable. Two variables are connected if and only if they appear in the same constraint expression. Then the edges of the directed graph are removed using the non-trivial dominance relation of the ACN: if A cannot influence B, then the edge from A to B is removed from the graph. We then compute the condensation graph of this graph. FIG. 12(a) shows a partial maze game condensation graph generated from the maze game ACN. Note that the edge directions in the graph may seem counter-intuitive. This is because the edges do not represent the direction of dependence but rather the direction of possible influence. In other words, if an edge (u, v) exists in the graph then a change in the decision of u may potentially influence the decision of v.

To generate sub-ACNs, all the variables along the paths ending with the same minimal elements are placed into a sub-ACN with the relevant subset of constraints, dominance relation, and cluster set. As a result, the ACN is decomposed into a set of sub-ACNs that can be solved individually. Each minimal element of the condensation graph represents a feature, and all the chains ending with a minimal element contain all the decisions needed to realize the feature. For example, FIG. 12(a) shows that one of the sub-ACNs will contain the variables BombedWall_impl, BombedWall_interface, Wall_interface, and MapSite_interface. This sub-ACN contains all the decisions needed to implement the BombedWall_impl.

Simply identifying all the decisions needed for a feature does not guarantee that the tasks can be implemented or changed independently because some of the decisions may be shared by other tasks. For example, the BombedWall_impl sub-ACN contains decisions, such as MapSite_interface, that overlap with other tasks in the condensation graph. We differentiate the sub-ACNs in FIG. 12(a) with different line styles and label them as S₁, S₂, and S3 for illustration.

A goal is to identify a hierarchy from the condensation graph that is generated as a by-product of the Decompose-Modules algorithm, and further decompose these sub-ACNs into independent tasks. This hierarchy is called the design rule hierarchy because the hierarchy is determined by the design rules, formalized as the dominance relation of the ACN.

Intuitively, the BACN algorithm identifies each region of intersection in the condensation graph and separates each into an individual group. For example, there are two regions of intersection in FIG. 12(a). In the intersection S₁∩S₂∩S₃, MapSite_interface is shared by all three sub-ACNs so a new module is created exclusively comprising it. Since the variable in this intersection is shared by all the sub-ACNs, its development is completed first. The other region of intersection, between S₂ and S₃, contain Room_interface so a new module is created comprising it. Similarly as before, since S₂ and S₃ share this variable, it is designed before the design of the concrete Room classes. Since S₂ and S₃ no longer share any variables, they are identified as concurrent tasks. FIG. 12(b) shows the hierarchy the BACN algorithm produces from FIG. 12(a) after aggregating these intersections into separate modules.

Since the resulting graph after applying this algorithm is directed acyclic, a modified breadth first search of the vertices can be applied and a partial ordering can be obtained. In other words, if the tasks in FIG. 12(b) are completed from the top down, then there is no need to wait for dependencies to be completed. FIG. 10 shows the DSM of the full maze game example in which the variables are clustered according to the result of our algorithm. All the dependencies in the DSM are either below the diagonal or within the inner groups. This is referred to as being in block triangular form. As described below, the BACN algorithm always produces a clustering that puts a DSM in block triangular form.

Formalization

In this section, the design rule hierarchy is defined, the clustering algorithm is presented, its correctness is proven, and its complexity is analyzed. A DR hierarchy is a directed acyclic graph (DAG) where each vertex models a task; each task is defined as a set of design decisions that should be made together. Edges in the graph model an “assumes” relation: an edge (u, v) models that the decision v assumes decision u. Based on ACN modeling, a change in the choice for u may cause a change in the choice for v. The layers within the DR hierarchy obey the following rules:
Layer 0 is the set of tasks that assume no other decisions.
Layer i (i≧1) is the set of all tasks that assume at least one decision in level i−1 and assume no decisions at a layer higher than i−1. Within any layer, no task assumes any decisions in another task of the same layer. Hence, the tasks within the same layer can be completed independently and in parallel.
The highest layer is the set of independent modules. No decisions outside of these modules makes assumption about any decisions within these modules.

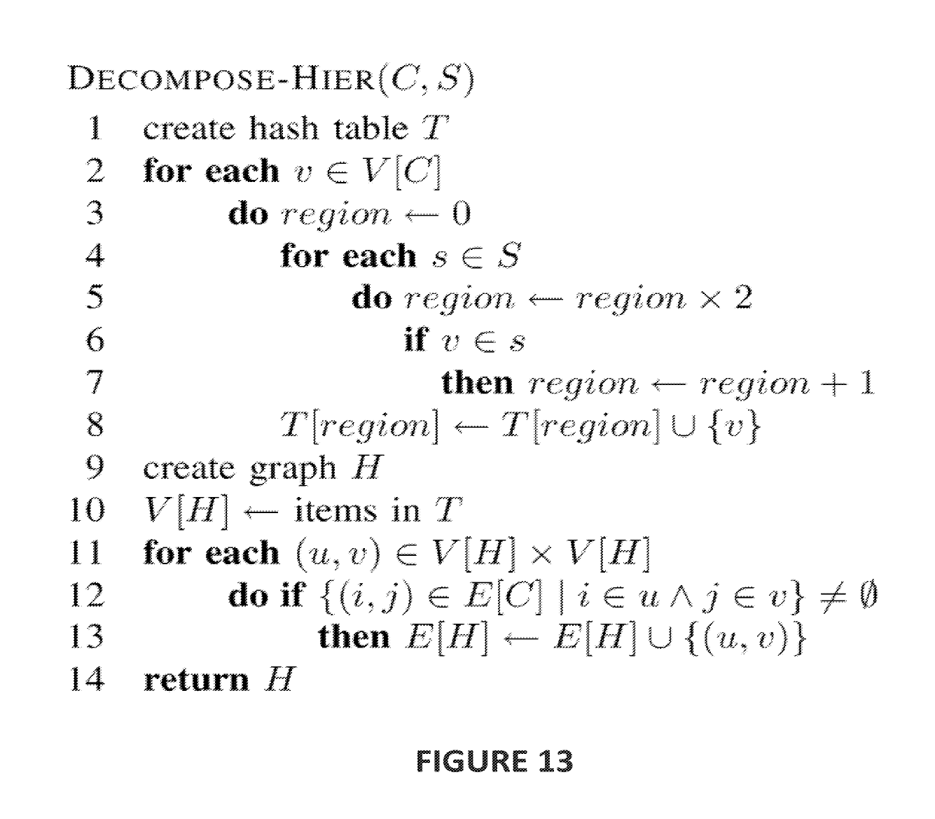

The DR hierarchy algorithm starts by identifying all the decisions needed for each feature, using the Decompose-Modules algorithm to decompose an ACN into sub-ACNs. Decompose-Modules take as input a directed graph G (representing the constraint network) and the dominance relation pairs. It creates a condensation graph C from G, and outputs a set of sub-ACNs S. The BACN algorithm takes both C and S as input, and outputs a clustering that conforms to the formal definition of DR hierarchy. FIG. 13 contains example pseudo code of the BACN algorithm.

As previously described, intuitively, the BACN algorithm separates each region of intersection of the sub-ACNs into a separate group. To identify which region a vertex of C belongs to, an identifying bit-field of |S| bits (represented by the integer region in the pseudo code) is assigned to each vertex. For each sub-ACN sᵢ∈S, if a vertex is contained in that sub-ACN then the i-th bit of its bit-field will be set to 1. For example, in FIG. 12(a), Room_interface is contained in sub-ACNs S₂ and S₃ so it would have an identifying bit-field of 110 and Wall_interface is only contained in sub-ACN s1 so it would have a bit-field of 001.

After identifying regions, a new graph H is built, in which each vertex represents a region. The final for-loop in the pseudo code populates the edges of H based on edges in the condensation graph C. The graph H contains the hierarchical structure of tasks based on the “assumes” relation. To derive the DR hierarchy clustering from H, first the independent modules are isolated, then a modified breadth-first search (BFS) is performed on the graph. The traversal is modified so that a vertex is not explored until all its incoming neighbors have been explored. A modified BFS is used instead of a simple topological sort because it is desired to identify the layer to which each vertex belongs. Performing a topological sort would create a valid partial ordering but the layers would not be explicitly identified.

To prove correctness and to show that the BACN algorithm correctly finds a hierarchical structure, Theorem 1 is proved below. To simplify this proof, first Lemma 1 is proved.

Lemma 1:

If vⱼ, . . . , vₖ is a path in the condensation graph C, then for any sub-ACN s∈S if vₖ∈s then vⱼ∈s.

Proof:

Let u be a minimal element in C such that there is a path vk [symbol] u (without loss of generality, assume that a path can consist of a single vertex if vₖ=u). There must be at least one unique u∈C because C is a DAG. The Decompose-Modules algorithm builds a sub-ACN from u by putting all vertices that are connected to u in the sub-ACN. Since vₖ is connected to u, it is in the sub-ACN; since vⱼ is connected to vₖ and vₖ is connected to u, vⱼ is also in the sub-ACN.

Theorem 1:

The hierarchy graph H is a DAG.

Proof:

Since the input condensation graph C does not contain any cycles, the only way that a cycle can be formed in H is by the clustering of vertices of C. For example, if a simple path p=v₁, v₂, . . . , vₖ exists in C, and a vertex is created in H containing v₁ and vₖ then a cycle would be formed. We assume by contradiction, that v1 and vk are clustered together in H. Then by definition, for all sub-ACNs s∈S v₁∈s iff vₖ∈s. For a cycle to be formed, at least one vertex in v₂, . . . , vₖ−1 must not be clustered with v₁ and vₖ; let vᵢ be this vertex. If vᵢ is not clustered with vₖ then there exists at least one sub-ACN s′∈S such that one, but not both, of vᵢ and vₖ is in s. Consider each case separately:

vₖ∈s′ [symbol] vᵢ∉s′
Since vᵢ is in the path p, there exists a path vᵢ [symbol] vₖ. By Lemma 1, if vₖ∈s′ then vᵢ must also be in s′. Hence, this scenario never occurs.

vₖ∈s′ [symbol] vᵢ∈s′
Since vᵢ is in the path p, there exists a path v₁ [symbol] vᵢ. By Lemma 1, if vᵢ∈s′ then v₁ must also be in s′ but this contradicts the original assumption. The contradiction occurs because it was assumed that for all sub-ACNs s∈S, v₁∈s iff vₖ∈s, but this scenario would have vₖ∈s′ but v₁∈s′.

Therefore, v₁ and vₖ cannot be clustered together to form a cycle in H. This proof can easily be extended to show that cycles cannot be formed by clustering together ends of multiple paths. For sake of space, this is not presented here. Since the graph is a DAG, it can be guaranteed that the corresponding DSM will be clustered into block triangular form.

Complexity Analysis: To show the running time for the BACN algorithm, first the size of its inputs is bound. All |V [C]|, |S|, and |V [H] are bounded by the number of variables in the ACN |V| because each vertex or sub-ACN must contain at least one variable. From this, it is known that each of the first two for-loops of the BACN algorithm will run in Θ (|V|) time and the last for-loop runs in Θ (|V|²) time. Breadth-first search runs in linear time so the total running time of the BACN algorithm is Θ (|V|²).

Evaluation

The DRH algorithm is implemented as a component of the ACN modeling and analysis tool, Minos. Minos supports ACN modeling, DSM derivation, changeability analysis, etc. To evaluate whether the DRH algorithm can correctly identify design rules, reveal their impact scope, and reveal independent modules, used were both the small but canonical key word in context (KWIC), and Minos itself as experimental subjects.

To evaluate the effectiveness of DRH in terms of predicting communication requirements and independent tasks, Apache Ant was used as the subject, and both its source code repository and developers' mailing list were explored to identify tasks and analyze communications among members of the development team engaged in those tasks. This socio-technical information was used to establish evidence of the need for technical communication between developers that have worked on modules indifferent layers (a opposed to within the same layer) of the DR hierarchy.

Keyword in Context

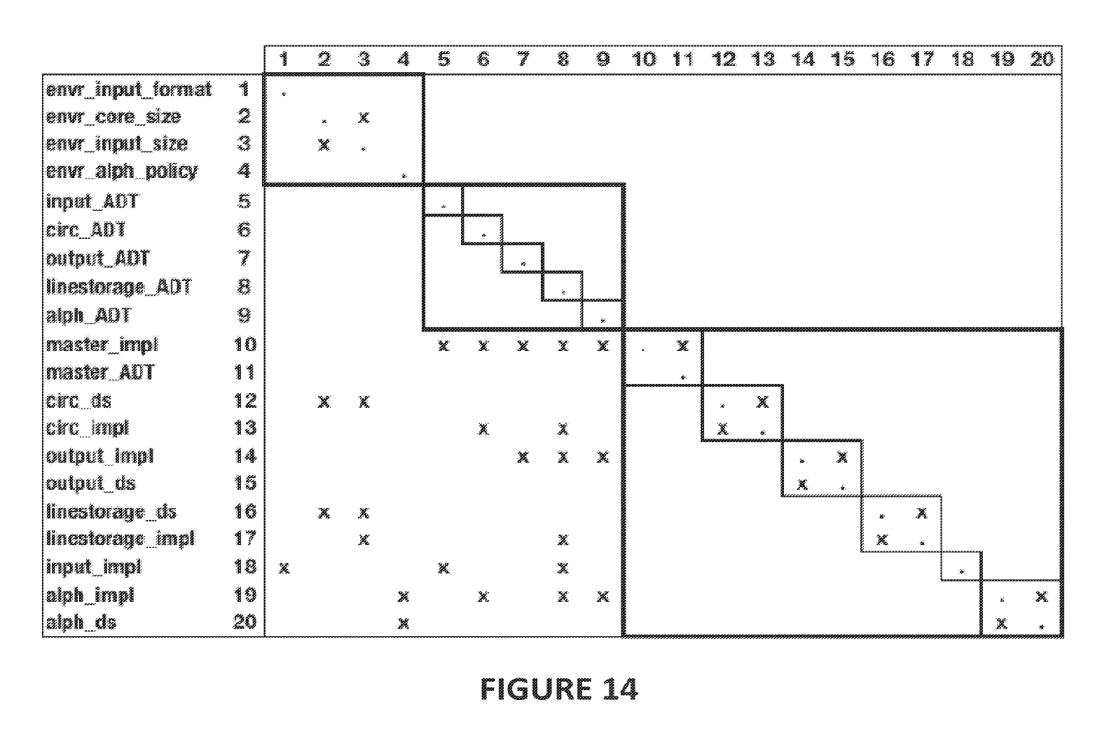

To evaluate the correctness of the DR hierarchy clustering algorithm, DR hierarchy-clustered DSMs were compared with previously validated DSMs, in which the design rules are manually identified and the modules are manually clustered. It was checked whether the DR hierarchy-clustered DSMs identify the same set of DRs and independent modules as the previously published DSMs. If not, we investigate what causes the discrepancies. A manually constructed ACN model of the system was used as input to the BACN algorithm. An automatically generated hierarchy was slightly modified by moving all the environment variables to a standalone module. FIG. 14 shows a DSM of KWIC with this modified hierarchy. Since environmental conditions do not depend on design decisions, the DSM is still in block triangular form.

In comparing the DR hierarchy-clustered DSM with the manually clustered DSM, only one difference was noticed: the DRH algorithm does not identify master_ADT as a design rule as the DSMs did. It was observed that the only dependent of master_ADT, in the specified design of KWIC, is master_impl. Based on the definition of design rules, the BACN algorithm's classification of master_ADT is correct: design rules are meant to decouple subordinate modules but master_ADT does not decouple two modules. As a result, the approach correctly classifies it as not being a design rule. It is concluded that the approach accurately identifies the design rules and independent modules in the KWIC design.

Minos

Minos is the ACN modeling and modularity analysis tool. It allows the user to build an ACN using its GUI, or to open an existing ACN that may be automatically transformed from other design models. Given an ACN model, Minos can generate its DSM, analyze change impact, or cluster a DSM into a design rule hierarchy. Minos has about 10 KLOC of Java code, and employs a plugin architecture. To generate the DRH for Minos, the source code was first reverse engineered into a UML class diagram, and then the UML class diagram was transformed into an ACN. Minos then takes the ACN as input and can compute the DRH-clustered DSM for itself.

The resulting hierarchy shows 5 layers. Of all the 149 variables, 33 of them (22%) are aggregated into 24 modules within the first layer. 94 variables (63%) are clustered into 51 modules in the last layer. After carefully examining each layer, it was confirmed that design rules are correctly identified and the locations of these DRs reflect their importance level. For example, the first layer aggregates all of the most influential decisions, such as util Graph interface and Minos Plugin interface.

It also was found that the 51 modules in the last layer include 16 out of the total 18 plugins, each modeled as a block with at least two variables. For example, the DRH clustering plugin is modeled as 4 variables that are automatically aggregated into a module in the last layer. The fact that two plugins, Decomposer and cluster FileWriter are not in the last layer drew attention. After examining the dependencies shown on the DSM, it was realized that unexpected dependencies had been erroneously introduced during evolution and maintenance activities of the Minos software. Their effect is to push these two plugins up the hierarchy. It was concluded that the DRH clearly lays out the plugin architecture, and even helped identify some hidden, poor design decisions.

Apache Ant

To evaluate the feasibility of applying the approach to a large-size, real-world project, conducted were experiments with the popular, open-source Apache Ant project. Specifically, release 1.6.5 was selected as the target, and its ACN model was extracted by reverse engineering its UML class diagram from the code base. The Apache Ant UML model contains approximately 500 classes and interfaces (including inner classes), and almost 2,500 inter-element relations.

An ACN was derived from the UML class diagram, and a DRH was derived from that ACN, in about 15.5 minutes on a 2.16 GHz Intel MacBook Pro laptop with 3 GB of RAM, and produced a DR hierarchy-clustered DSM that includes 12,596 pairs of dependencies among those 1,000 variables.

Since, according to one proposition, no modules depend on independent modules in the last layer, they provide the option to be substituted with better implementations at minimal cost. Therefore, the number of independent modules can be used in a system as an indicator of its design quality. Despite having over 500 classes and 1000 variables in its DSM, the Apache Ant DR hierarchy comprised only 11 layers. When compared with, for instance, the maze game example, it can be sees that although Apache Ant has 40 times the number of DSM variables, it has about only twice the number of layers in its DR hierarchy. This means that most modules in the system are aggregated horizontally within layers, and can be highly parallelized. In addition, 52% of the tasks identified are in the independent modules layer, indicating that much of the system constitutes options that can be freely substituted. Both of these DR hierarchy characteristics indicate that Apache Ant is well modularized, and easy to maintain and evolve. Another work further investigates the use of the DR hierarchy for defining metrics on software architecture modularity and stability.

When maintaining a software system, especially an unfamiliar one, it is crucial not to accidentally change parts of the system that are highly influential. Conducted was a test to see if a DRH can provide an order for design rules, in terms of their influence, so that developers can be aware of these most influential parts.

Apache Ant DSM was examined and the number of dependencies were counted to determine if the identified design rules are indeed the most influential. The more other variables depend on a given design rule, the more influential that is. Even though a DSM is in block triangular form, it does not mean that the variables furthest to the left are the most influential. There may be some variables further to the right that depend on the left-most variables, whereas a larger portion of the rest of the system depends on them.

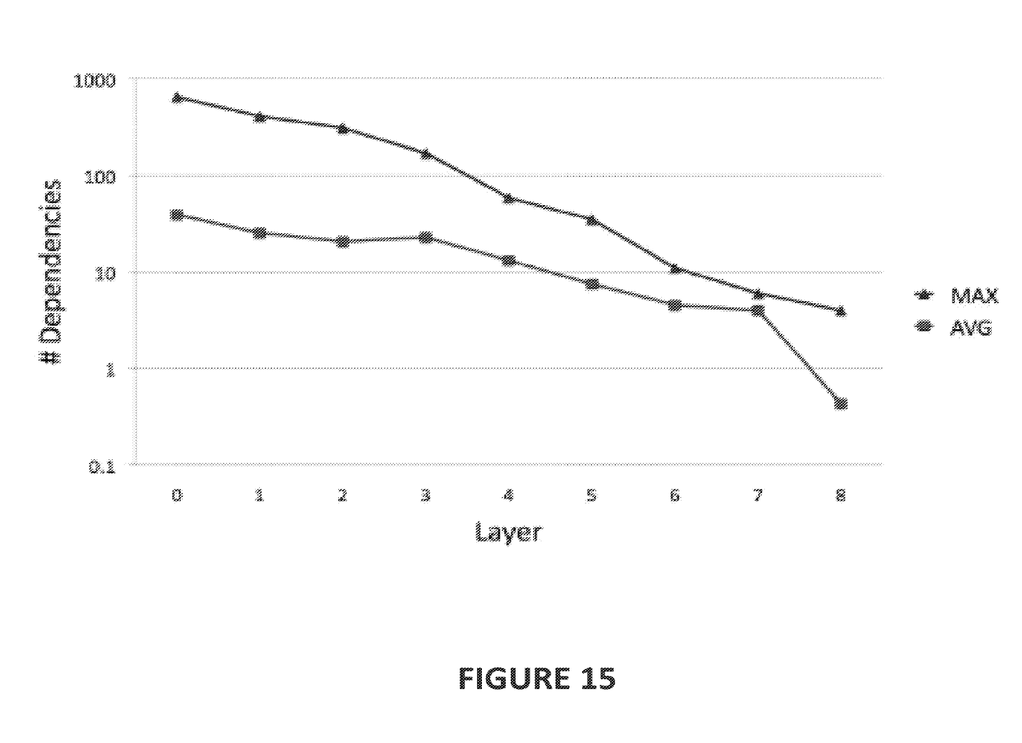

To verify if the identified design rules are the most influential, the DSM was used to count the number of dependencies upon each variable. FIG. 15 shows a graph of the average and maximum number of dependencies for each layer of the DR hierarchy. Notice that the vertical axis is in a logarithmic scale. From the graph, it can be seen that the variables in layer zero have the most dependencies upon them. These high-level dependencies indicate that if a variable in layer zero were to change, it would impact much of the system. In other words, the variables in layer zero are highly influential on the rest of the system. Since both the maximum and average number of dependencies decrease at each layer of the hierarchy (except for between layer 2 and 3, where there is a slight increase in the average number of dependencies), it can be concluded that each layer of the DR hierarchy is less influential than the one before it.

It was set out to test whether the DR hierarchy can effectively identify modules that correspond to independent and parallelizable tasks. Modules located within the same DRH level are supposed to be mutually independent, and thus constitute candidates for independent task assignments. To validate that assumption, a look was taken at the work and communication dynamics of the Apache Ant team, during the transition from release 1.6.5 to the subsequent release, that is, 1.7.0.

The method of the analysis descends from recent results on socio-technical congruence, which indicate how to establish and analyze the coordination requirements between developers working on concurrent tasks. A coordination requirement occurs when two developers, say, Alice and Bob, are assigned to concurrent development tasks, and those tasks require them to work on sets of software artifacts that present some dependencies. In those cases, some form of coordination between Alice and Bob is often necessary; for example, Alice and Bob may exchange some technical communication, which is often archived—in particular in open-source projects—and hence traceable. On the other hand, if Alice and Bob work concurrently only on mutually independent modules, their need for coordination can be greatly attenuated.

Based on the concept of coordination requirements, and the semantics assigned to DSM dependencies and DR hierarchy levels, the following hypotheses have been formulated:
1) Technical communication between any two developers who are engaged in concurrent work modules that are located within the same hierarchy level should be least intense. This hypothesis aims at verifying that those modules are good examples of independent task assignments, and do not present involved Ant developers with coordination requirements.
2) Technical communication is likely to occur significantly more frequently “across layers”, e.g., between any two developers who are engaged in concurrent work on modules located in different layers of the hierarchy, and are dependent on one another. This hypothesis aims at verifying that the layered dependency structure provided by the DR hierarchy provides a good indication of where coordination is needed, and how it flows in the project.

For the analysis of Apache Ant, collected were all commits of Java code in the Ant SVN repository during the development of release 1.7.0 (which lasted 19 months), as well as all message exchanges within the developers' mailing list of the project by the 14 active committers for Apache Ant. The tree structure of each mailing list thread was traversed, and considered as a communication exchange between two developers was any direct reply by one of them to a message posted by the other.

To identify development tasks, devised was a strategy to overcome the fact that the data set that could be mined has only sparse information linking tasks to specific code commits within the source code repository. For example, only a small portion (about 15%) of the change requests, bug fixes, and other work items listed in the projects' Bugzilla are referenced within the meta-data of Java code commits for Ant v.1.7.0. A sliding time window was therefore used to approximate the concept of parallel tasks with that of concurrent work. For each of the 866 commits involving any of the 1133 Java files, a 2-week time window was computed, and considered were any commits by other developers within that window as concurrent work. (The choice of 2 weeks as the dimension of the time window was suggested by examining the typical length of development tasks in the project, mediated by the frequency of communication exchanges observed within the developers mailing list).

With this mechanism, all distinct pairs of developers committing Java code within the same time window would be considered as engaging in concurrent work. 742 such pairs were identified. Then, eliminated were those pairs in which either developer was responsible for commits that had to do with simultaneous blanket changes on a large number of files (more than 56, that is, 5% of the overall java codebase). Commits of that kind are typically extraneous to actual development tasks. For example, they occur when versioning, copyright or licensing information needs to be updated in the comment section of all source files; or when name change refactoring to widely used code item is performed; or in case of other trivial housekeeping activities on the code base.

That filter provided 653 developer pairs, upon which further analysis was carried out. First of all, matched were the commits by each developer to the variables represented in the DSM. That way, obtained was a list of the variables in each DSM module that could be affected by the changes made to the Ant code base by a developers pair for a given time window. That provided us with a basis to locate concurrent work by a developer pair (say, Alice and Bob) within the DSM; then the following subgroups from the population of 653 pairs were extracted:
1) If Alice and Bob have done concurrent work affecting any pair of variables that have a dependency relationship and are located in different DSM modules, count those pairs of variables and place them in the Across Layers—AL category;
2) If Alice and Bob have done concurrent work affecting any pair of variables that have a dependency relationship and are located in the same DSM module, count those pairs of variables and place them in the Same Layer Same Module—SLSM category;
3) If Alice and Bob have done concurrent work affecting any pair of variables that are located in different modules within the same layer of the DR hierarchy (which by definition have no dependency), count those pairs of variables and place them in the Same Layer Different Module—SLDM category;

To complement that information, the number of mailing list exchanges between Alice and Bob within the same time window were counted.

For any time window and for any pair of developers, it is of course possible that those developers have carried out work that falls into more than one of the above categories. That is important, because whenever a pair of developers has a count >0 for either the SLSM or AL category, that indicates the presence of at least one coordination requirement. In fact, 347 out of 653 pairs have a count of AL>0. There are also 144 pairs who have coordination requirements originating from SLSM work, but the vast majority of them are also included in the set with AL>0: only 9 pairs have a count of SLSM>0 and AL=0. All in all, therefore, 356 pairs exhibited some form of coordination requirement. (This will be referred to as the “CR group”).

Similarly, identified were the 266 pairs who exclusively did SLDM work in some given time window, that is, whose SLDM count was >0, and at the same time had both an SLSM and AL count of 0 (This will be referred to as the “SLDM group”).

Coming to technical communication data, out of the 266 pairs in the SLDM group, it was found that 89 pairs exchanged mailing list messages, that is, about 33%. In contrast, about 53% of the pairs in the CR group exchanged messages. That percentage amounts instead to 43% when considering the overall set of 653 pairs.

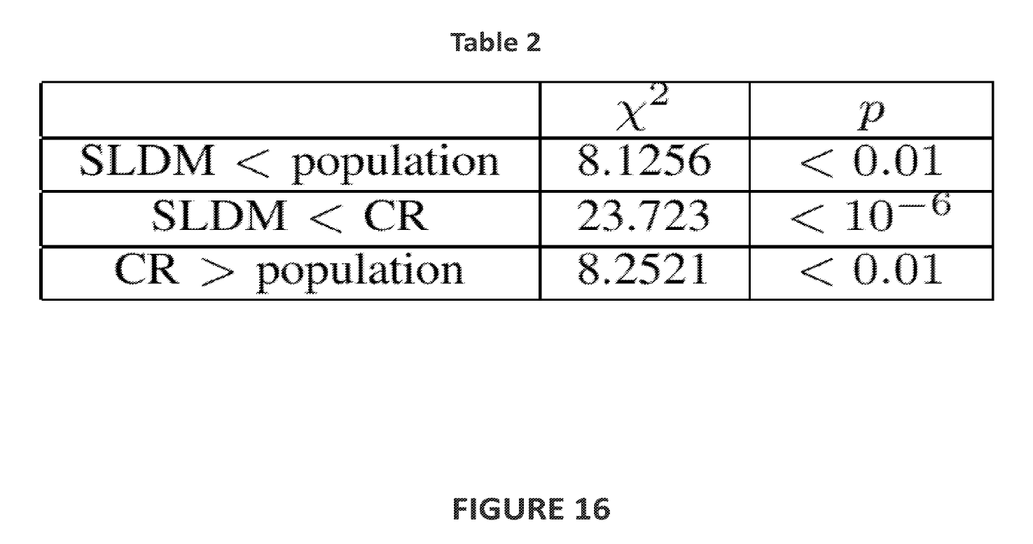

First of all, it was set out to verify whether the difference in proportion among these groups could be considered significant. To that end, carried out were pair wise chi-square tests of proportion between the various groups, and between each group and the overall population. The results, which are summarized in Table 2 of FIG. 16, show how the differences in proportion are indeed statistically significant. In particular, it is confirmed with a very high degree of confidence that the proportion of communicating pairs in the SLDM group is significantly less than that of the CR group. Also the proportion of communicating pairs in the SLDM group is significantly less than that of the overall population; similarly, the proportion of communicating pairs in the CR group is significantly more than that of the overall population. All of these observations are consistent with the hypotheses.

Since, however, a ratio of technical communication of 33% within the SLDM group seemed to be high in absolute terms, given the absence of coordination requirements, carried out were further statistical analysis, to try to understand whether such as 33% ratio could be considered as a sort of natural level of “chatter” within the communication channel provided by the developers mailing list, whereas higher ratios, such as 53% within the CR group could be indeed described as a consequence of doing interdependent concurrent work. To investigate that, it was set out to verify the additional hypotheses below:
1) The probability of communication between pairs in the SLDM group is not correlated to the amount of SLDM work they have concurrently carried out, that is, the amount of different pairs of DSM variables affected by their commits in the time window considered. In contrast, the probability of communication between pairs in the CR group is correlated to the amount of dependent work they have concurrently carried out.
2) The amount of communication, that is, the count of messages, exchanged in the time window considered, between those pairs in the SLDM group that communicated is not correlated to the amount of SLDM work they have concurrently carried out. In contrast, the amount of communication exchanged between pairs in the CR group that communicated is correlated to the amount of dependent work they have concurrently carried out.

For the first additional hypothesis above, a point-biserial correlation test between the count of pairs of DSM variables touched by the 266 pairs in the SLDM group, and a Boolean variable indicating whether those developer pairs communicated at least once provided an r-score of 0.00206, which is consistent with no correlation. That sharply contrasts with the result of the same statistical test performed on the 356 pairs in the CR group. The r-score is 0.299, which denotes a strong positive correlation; moreover, that correlation is extremely statistically significant, with p<10⁻⁸. These results confirm the hypothesis, since they strongly suggest that the amount of SLDM work of a pair of developers and their probability of communication do not influence each other; on the contrary, the amount of dependent work that produces coordination requirements for a pair of developers and the probability of technical communication between them are strongly linked.

For the second additional hypothesis above, performed was a Pearson correlation test between the count of pairs of DSM variables touched by the 89 pairs of developers in the SLDM group who exchanged messages, and the number of messages they exchanged. The r-score in this case is −0.05626, which is again consistent with no correlation. In the case of the 188 pairs of developers in the CR group who exchanged messages, the same statistical test returns an r-score of 0.189, which denotes a weak positive correlation. That correlation is quite significant statistically, with p<0.01 (p=0.0048). These results confirm the second hypothesis, since they suggest that the amount of SLDM work and the amount of communication do not influence each other; on the contrary, the amount of dependent work and the amount of communication are linked to each other.

From the comparative analysis above, it is concluded, with confidence, that the 33% ratio of communication within the SLDM group is unlikely to be a consequence of any hidden coordination requirements among modules in the same layer of the DRH, or an artifact of some conceptual or technical error in the DRH construction process. The statistical evidence points instead to that ratio as being independent of coordination requirements, and it can probably be regarded as a property of the communication channel considered. The result also suggests that the dependency structure derived from the ACN model and clustered using DRH sufficiently approximates the corresponding coordination structure.

Organization of software as a layered, hierarchical structure has been advocated for many years. Today, the layered style is popular in software architecture. A difference with the herein described DRH layers is that the modules in the existing architectures are often defined based on classes, or other programmatic elements, whereas the modules in the herein described approach are independent task assignments.

A DRH is different also from other known hierarchical structures, such as the “uses” hierarchy and hierarchies defined according to conceptual domains. For example, if a decision A in a GUI layer is the only decision to depend on a decision B in the business layer, then the herein described DR hierarchy algorithm will aggregate A and B into a task module because these decisions can and should be made and changed together.

Known project management and scheduling algorithms that consider task dependencies, available skills, and resource constraints expect a task graph as an input. The herein described approach complements this approach in that the DRH can be used as an input task graph to those algorithms. Those algorithms can be used to elaborate on the herein described hierarchy's task assignments while considering other issues such as resource constraints.

To determine the order of class integration when testing object-oriented software, some graph-based algorithms identify strongly-connected components (SCCs) and perform topological sorting to obtain a partial ordering. Heuristics are presented to break cycles within each SCC and reduce the effort of creating stubs for tests. Although the herein described approach also identifies SCCs in a graph (for constructing the condensation graph), the herein described approach does not need to break cycles in the graph because cycles represent cohesion and the herein described approach identifies modules based on this cohesion. In addition, the modules identified by the herein described algorithm do not directly correspond to the SCCs of a graph.

The Lattix tool automatically reverse engineers a DSM from a code base and provides several partitioning algorithms to identify modules and reorder the DSM into block triangular form. It was tried to cluster the maze game DSM to see if these algorithm can generate a clustering similar to the herein described DR hierarchy. The results show that even if Lattix is manually fed with the dependencies derived from the CAN (because it does not detect indirect or implicit dependencies between variables), the partitioning algorithm either generates modules that are not cohesive, containing classes with dramatically different semantics, or do not correctly reveal the order of design rules, for example, it does not identify the Maze interface as a top level design rule.

The herein described approach is unique because, among other reasons, other object-oriented modeling methods do not separate the interface and implementation dimensions for the purpose of task assignments, nor identify indirect and implicit dependencies.

As described herein, a design rule hierarchy is used to predict coordination requirements, to suggest task assignments that maximize parallelism, and to reveal the impact scope of design rules. This hierarchy was evaluated using Apache Ant, Minos, and KWIC. By investigating the repository of Apache Ant and its developers' mailing list, it was shown that technical communication among developers working on different modules in the same hierarchy layer is significantly less intense than that required by developers working across layers, supporting the coordination prediction hypothesis of our hierarchy. Using Minos and KWIC, it also was shown that the hierarchy faithfully reveals design rules and their level of importance. The experiments demonstrate the potential of the DRH model for reasoning and making predictions about the interplay between design structure, coordination structure and task assignment.

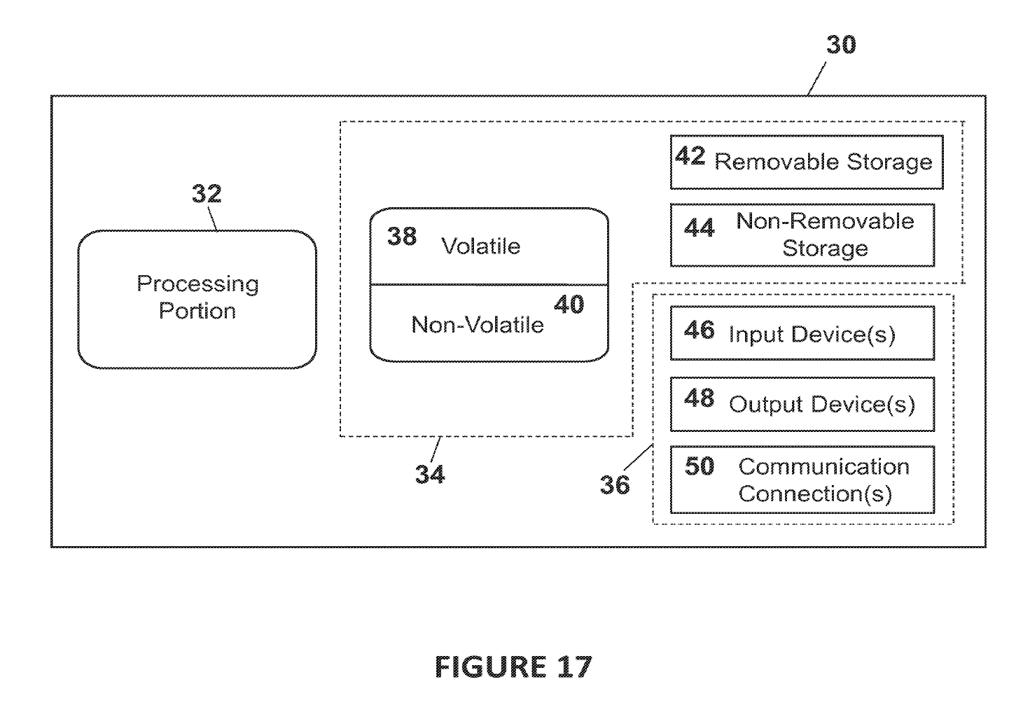

FIG. 17 is a block diagram of an example processor 30 configured to appropriately implement and/or generate a design rule hierarchy, task parallelism, and/or dependency analysis as described herein. The processor 30 comprises hardware or a combination of hardware and software. The processor 30 can include any appropriate device, mechanism, software, and/or hardware for appropriately implement and/or generate a design rule hierarchy, task parallelism, and/or dependency analysis as described herein. As described herein, the processor 30 comprises hardware, or a combination of hardware and software. And, each portion of the processor 30 comprises hardware, or a combination of hardware and software. The functionality needed to appropriately implement and/or generate a design rule hierarchy, task parallelism, and/or dependency analysis as described herein can reside in any one or combination of processors. The processor 30 depicted in FIG. 17 represents any appropriate processor, or combination of processors, such as a server, a computer, etc., or any combination thereof. In an example configuration, the processor 30 comprises a component or various components of a cellular broadcast system wireless network. It is emphasized that the block diagram depicted in FIG. 17 is exemplary and not intended to imply a specific implementation or configuration. Thus, the processor 30 can be implemented in a single processor or multiple processors (e.g., single server or multiple servers, single computer or multiple computers, etc.). Multiple processors can be distributed or centrally located. Multiple processors can communicate wirelessly, via hard wire, or a combination thereof.

In an example configuration, the processor 30 comprises a processing portion 32, a memory portion 34, and an input/output portion 36. The processing portion 32, memory portion 34, and input/output portion 36 are coupled together (coupling not shown in FIG. 17) to allow communications therebetween. The input/output portion 36 is capable of receiving and/or providing information from/to a device and/or processor configured to be utilized with appropriately implementation and/or generation of a design rule hierarchy, task parallelism, and/or dependency analysis as described herein. In various configurations, the input/output portion 34 can receive and/or provide information via any appropriate means, such as, for example, optical means (e.g., infrared), electromagnetic means (e.g., RF, WI-FI, BLUETOOTH, ZIGBEE, etc.), acoustic means (e.g., speaker, microphone, ultrasonic receiver, ultrasonic transmitter), or a combination thereof. In various configurations, the input/output portion 34 can receive and/or provide information wirelessly, via a wired connection, or a combination thereof.

The processing portion 32 is capable of performing functions associated with appropriately implement and/or generate a design rule hierarchy, task parallelism, and/or dependency analysis as described herein.

The memory portion 34 can store any information utilized in conjunction with appropriately implement and/or generate a design rule hierarchy, task parallelism, and/or dependency analysis as described herein. Depending upon the exact configuration and type of processor, the memory portion 34 can include computer readable storage media that is volatile 38 (such as dynamic RAM), non-volatile 40 (such as ROM), or a combination thereof. The processor 30 can include additional storage, in the form of computer readable storage media (e.g., removable storage 42 and/or non-removable storage 44) including, but not limited to, RAM, ROM, EEPROM, tape, flash memory, smart cards, CD-ROM, digital versatile disks (DVD) or other optical storage, magnetic cassettes, magnetic tape, magnetic disk storage or other magnetic storage devices, universal serial bus (USB) compatible memory, or any other medium which can be used to store information and which can be accessed by the processor 30. As described herein, a computer-readable storage medium is an article of manufacture, and thus not a transient signal.

The processor 30 also can contain communications connection(s) 50 that allow the processor 30 to communicate with other devices, processors, or the like. A communications connection(s) can comprise communication media. Communication media typically embody computer readable instructions, data structures, program modules or other data in a modulated data signal such as a carrier wave or other transport mechanism and includes any information delivery media. By way of example, and not limitation, communication media include wired media such as a wired network or direct-wired connection, and wireless media such as acoustic, RF, infrared, and other wireless media. The term computer readable media as used herein includes both storage media and communication media. The processor 30 also can include input device(s) 46 such as keyboard, mouse, pen, voice input device, touch input device, etc. Output device(s) 48 such as a display, speakers, printer, etc. also can be included.

While example embodiments of a design rule hierarchy, task parallelism, and dependency analysis have been described in connection with various computing devices/processors, the underlying concepts can be applied to any computing device, processor, or system capable of facilitate a security social network as described herein. The methods and apparatuses for facilitating, storing, and/or implementing a design rule hierarchy, task parallelism, and/or dependency analysis, or certain aspects or portions thereof, can take the form of program code (i.e., instructions) embodied in tangible storage media having a physical structure, such as floppy diskettes, CD-ROMs, hard drives, or any other machine-readable storage medium (computer-readable storage medium), wherein, when the program code is loaded into and executed by a machine, such as a computer, the machine becomes an apparatus for implementing a security social network. Further, data structures indicative of and/or associated with a design rule hierarchy, task parallelism, and/or dependency analysis as described herein can be stored in a computer-readable medium. A computer-readable storage medium, as described herein is an article of manufacture and not a transient signal. In the case of program code execution on programmable computers, the computing device will generally include a processor, a storage medium readable by the processor (including volatile and non-volatile memory and/or storage elements), at least one input device, and at least one output device. The program(s) can be implemented in assembly or machine language, if desired. The language can be a compiled or interpreted language, and combined with hardware implementations.

The methods and apparatuses for a design rule hierarchy, task parallelism, and/or dependency analysis can be practiced via communications embodied in the form of program code that is transmitted over some transmission medium, such as over electrical wiring or cabling, through fiber optics, or via any other form of transmission, wherein, when the program code is received and loaded into and executed by a machine, such as an EPROM, a gate array, a programmable logic device (PLD), a client computer, or the like, the machine becomes an apparatus for appropriately implementing and/or generating a design rule hierarchy, task parallelism, and/or dependency analysis as described herein. When implemented on a general-purpose processor, the program code combines with the processor to provide a unique apparatus that operates to invoke the functionality a design rule hierarchy, task parallelism, and/or dependency analysis.

While a design rule hierarchy, task parallelism, and dependency analysis have been described in connection with the various embodiments of the various figures, it is to be understood that other similar embodiments can be used or modifications and additions can be made to the described embodiments for appropriately implementing and/or generating a design rule hierarchy, task parallelism, and/or dependency analysis as described herein. Therefore, a design rule hierarchy, task parallelism, and dependency analysis as described herein should not be limited to any single embodiment, but rather should be construed in breadth and scope in accordance with the appended claims.

1. A method for determining dependency relationships without solving constraints associated therewith, the method comprising:
generating an influence graph of the dependency relationships, wherein edges of the influence graph represent a potential pairwise dependence relationship (PWDR);
generating a compatibility graph of a constraint network, the compatibility graph being indicative of an existence of transitions in a non-deterministic finite automation; and
verifying a PWDR of the potential PWDRs by utilizing the compatibility graph.

2. The method of claim 1, further comprising:
generating an implication graph that models the constraints, wherein the influence graph and the compatibility graph are based on the implication graph.

3. The method of claim 1, further comprising:
generating an implication graph that models the constraints, wherein the influence graph is based on the implication graph.

4. The method of claim 1, further comprising:
removing invalid edges from the influence graph, wherein an invalid edge is indicative of a variable being a same value for all solutions of a constraint.

5. The method of claim 4, further comprising:
taking a transitive closure of the influence graph after invalid edges have been removed.

6. A processor comprising:
a processor portion configure to:
generate an influence graph of the dependency relationships, wherein edges of the influence graph represent a potential pairwise dependence relationship (PWDR);
generate a compatibility graph of a constraint network, the compatibility graph being indicative of an existence of transitions in a non-deterministic finite automation; and
verify a PWDR of the potential PWDRs by utilizing the compatibility graph; and
a memory portion configured to:
store a representation of the influence graph and a representation of the compatibility graph.

7. The processor of claim 6:
the processing portion further configured to:
generate an implication graph that models the constraints, wherein the influence graph and the compatibility graph are based on the implication graph; and
the memory portion further configured to:
store a representation of the implication graph

8. The processor of claim 6, the processing portion further configured to:
generate an implication graph that models the constraints, wherein the influence graph is based on the implication graph.

9. The processor of claim 6, the processing portion further configured to:
remove invalid edges from the influence graph, wherein an invalid edge is indicative of a variable being a same value for all solutions of a constraint.

10. The processor of claim 6, the processing portion further configured to:
take a transitive closure of the influence graph after invalid edges have been removed.

11-20. (canceled)

21. A computer-readable storage medium comprising executable instructions that when executed by a processor cause the processor to effectuate operation comprising:
generating an influence graph of dependency relationships, wherein edges of the influence graph represent a potential pairwise dependence relationship (PWDR);
generating a compatibility graph of a constraint network, the compatibility graph being indicative of an existence of transitions in a non-deterministic finite automation; and
verifying a PWDR of the potential PWDRs by utilizing the compatibility graph.

22. The computer-readable storage medium of claim 21, further comprising:
generating an implication graph that models the constraints, wherein the influence graph and the compatibility graph are based on the implication graph.

23. The computer-readable storage medium of claim 21, further comprising:
generating an implication graph that models the constraints, wherein the influence graph is based on the implication graph.

24. The computer-readable storage medium of claim 21, further comprising:
removing invalid edges from the influence graph, wherein an invalid edge is indicative of a variable being a same value for all solutions of a constraint.

25. The computer-readable storage medium of claim 24, further comprising:
taking a transitive closure of the influence graph after invalid edges have been removed.
